(19) United States
(12) Patent Application Publication
(10) Pub. No.: US 2026/0340482 A1
(43) Pub. Date: Oct. 29, 2026

(54) TRI-MATRIX LOW-RANK ADAPTATION OF ARTIFICIAL INTELLIGENCE OR MACHINE LEARNING MODELS

(71) Applicant: OKTA, INC., SAN FRANCISCO, CA (US)

(72) Inventor: Tanvir ISLAM, Lake Stevens, WA (US)

(21) Appl. No.: 19/189,069

(22) Filed: Apr. 24, 2025

(51) Int. Cl. G06N 20/00

(52) U.S. Cl. CPC G06N 20/00

(57) ABSTRACT

A system may utilize a fine-tuning operation to fine-tune a pre-trained artificial intelligence or machine learning (AI/ML) model. The system may generate a set of matrices that are indicative of a decomposition of a set of parameter weights associated with a task-specific parameters for the fine-tuning operation. The set of matrices may include one or more first matrices with one or more initialized values and a second matrix with one or more uninitialized values. The system may then train the second matrix to adjust the one or more uninitialized values. Moreover, the one or more initialized values of the second matrix may be associated with a subset of the task-specific parameters. Further, based on training the second matrix and a function, the system may obtain a fine-tuned model that includes a fine-tuned set of parameters associated with a fine-tuned set of parameter weights via the fine-tuning operation.

### FIELD OF TECHNOLOGY

The present disclosure relates generally to identity management, and more specifically to tri-matrix low-rank adaptation of artificial intelligence or machine learning models.

### BACKGROUND

An identity management system may be employed to manage and store various forms of user data, including usernames, passwords, email addresses, permissions, roles, group memberships, etc. The identity management system may provide authentication services for applications, devices, users, and the like. The identity management system may enable organizations to manage and control access to resources, for example, by serving as a central repository that integrates with various identity sources. The identity management system may provide an interface that enables users to access a multitude of applications with a single set of credentials.

An identity management system may utilize one or more artificial intelligence or machine learning (AI/ML) models such as large language models (LLMs). In some examples, an AI/ML model or an LLM may be fine-tuned to perform specific tasks or to solve specific problems. Fine-tuning an AI/ML model or LLM may include adjusting a set of pre-trained model weights utilizing task-specific data to refine how the AI/ML model understands and responds to queries based on a given context. In some examples, fine-tuning AI/ML models or LLMs may be relatively time consuming and can consume a relatively large quantity of resources. For example, a fine-tuning procedure may include training a relatively large quantity of parameters of a pre-trained model which can increase the computational overhead, resource consumption, and latency associated with utilizing AI/ML models or LLMs.

### SUMMARY

A method for fine-tuning an artificial intelligence or machine learning (AI/ML) model by an apparatus is described. The method may include obtaining a pre-trained model including a first set of parameters associated with a first set of parameter weights, generating, as part of a fine-tuning operation associated with fine-tuning the pre-trained model and based on obtaining the first set of parameter weights, a set of matrices that are indicative of a decomposition of a second set of parameter weights associated with a second set of parameters including one or more task-specific parameters for the fine-tuning operation that are different from the first set of parameters, the set of matrices including: one or more first matrices that include a respective first subset of parameter weights from the second set of parameter weights that are associated with a respective first subset of parameters from the second set of parameters, the respective first subset of parameter weights corresponding to one or more values initialized in accordance with a distribution function, and a second matrix that includes a second subset of parameter weights from the second set of parameter weights that are associated with a second subset of parameters from the second set of parameters, the second subset of parameter weights corresponding to one or more uninitialized values, training the second matrix by adjusting the one or more uninitialized values of the second subset of parameter weights associated with the second subset of parameters, and obtaining, via the fine-tuning operation, a fine-tuned model including a fine-tuned set of parameters associated with a fine-tuned set of parameter weights, the fine-tuned model being based on the pre-trained model, where the fine-tuned model is obtained based on training the second matrix and a function of an input associated with the pre-trained model, the first set of parameter weights, an adjustable scaling factor, the set of matrices including the decomposition of the second set of parameter weights associated with the second set of parameters, and a dropout function.

An apparatus for fine-tuning an AI/ML model is described. The apparatus may include one or more memories storing processor executable code, and one or more processors coupled with the one or more memories. The one or more processors may individually or collectively be operable to execute the code to cause the apparatus to obtain a pre-trained model including a first set of parameters associated with a first set of parameter weights, generate, as part of a fine-tuning operation associated with fine-tuning the pre-trained model and based on obtaining the first set of parameter weights, a set of matrices that are indicative of a decomposition of a second set of parameter weights associated with a second set of parameters including one or more task-specific parameters for the fine-tuning operation that are different from the first set of parameters, the set of matrices including: one or more first matrices that include a respective first subset of parameter weights from the second set of parameter weights that are associated with a respective first subset of parameters from the second set of parameters, the respective first subset of parameter weights corresponding to one or more values initialized in accordance with a distribution function, and a second matrix that includes a second subset of parameter weights from the second set of parameter weights that are associated with a second subset of parameters from the second set of parameters, the second subset of parameter weights corresponding to one or more uninitialized values, train the second matrix by adjusting the one or more uninitialized values of the second subset of parameter weights associated with the second subset of parameters, and obtain, via the fine-tuning operation, a fine-tuned model including a fine-tuned set of parameters associated with a fine-tuned set of parameter weights, the fine-tuned model being based on the pre-trained model, where the fine-tuned model is obtained based on training the second matrix and a function of an input associated with the pre-trained model, the first set of parameter weights, an adjustable scaling factor, the set of matrices including the decomposition of the second set of parameter weights associated with the second set of parameters, and a dropout function.

Another apparatus for fine-tuning an AI/ML model is described. The apparatus may include means for obtaining a pre-trained model including a first set of parameters associated with a first set of parameter weights, means for generating, as part of a fine-tuning operation associated with fine-tuning the pre-trained model and based on obtaining the first set of parameter weights, a set of matrices that are indicative of a decomposition of a second set of parameter weights associated with a second set of parameters including one or more task-specific parameters for the fine-tuning operation that are different from the first set of parameters, the set of matrices including: one or more first matrices that include a respective first subset of parameter weights from the second set of parameter weights that are associated with a respective first subset of parameters from the second set of parameters, the respective first subset of parameter weights corresponding to one or more values initialized in accordance with a distribution function, and a second matrix that includes a second subset of parameter weights from the second set of parameter weights that are associated with a second subset of parameters from the second set of parameters, the second subset of parameter weights corresponding to one or more uninitialized values, means for training the second matrix by adjusting the one or more uninitialized values of the second subset of parameter weights associated with the second subset of parameters, and means for obtaining, via the fine-tuning operation, a fine-tuned model including a fine-tuned set of parameters associated with a fine-tuned set of parameter weights, the fine-tuned model being based on the pre-trained model, where the fine-tuned model is obtained based on training the second matrix and a function of an input associated with the pre-trained model, the first set of parameter weights, an adjustable scaling factor, the set of matrices including the decomposition of the second set of parameter weights associated with the second set of parameters, and a dropout function.

A non-transitory computer-readable medium storing code for fine-tuning an AI/ML model is described. The code may include instructions executable by one or more processors to obtain a pre-trained model including a first set of parameters associated with a first set of parameter weights, generate, as part of a fine-tuning operation associated with fine-tuning the pre-trained model and based on obtaining the first set of parameter weights, a set of matrices that are indicative of a decomposition of a second set of parameter weights associated with a second set of parameters including one or more task-specific parameters for the fine-tuning operation that are different from the first set of parameters, the set of matrices including: one or more first matrices that include a respective first subset of parameter weights from the second set of parameter weights that are associated with a respective first subset of parameters from the second set of parameters, the respective first subset of parameter weights corresponding to one or more values initialized in accordance with a distribution function, and a second matrix that includes a second subset of parameter weights from the second set of parameter weights that are associated with a second subset of parameters from the second set of parameters, the second subset of parameter weights corresponding to one or more uninitialized values, train the second matrix by adjusting the one or more uninitialized values of the second subset of parameter weights associated with the second subset of parameters, and obtain, via the fine-tuning operation, a fine-tuned model including a fine-tuned set of parameters associated with a fine-tuned set of parameter weights, the fine-tuned model being based on the pre-trained model, where the fine-tuned model is obtained based on training the second matrix and a function of an input associated with the pre-trained model, the first set of parameter weights, an adjustable scaling factor, the set of matrices including the decomposition of the second set of parameter weights associated with the second set of parameters, and a dropout function.

Some examples of the method, apparatus, and non-transitory computer-readable medium described herein may further include operations, features, means, or instructions for obtaining an indication of an instruction to perform the fine-tuning operation, the instruction including an indication of one or more tasks and selecting, from the second set of parameters, a subset of task-specific parameters to train via the fine-tuning operation based on the subset of task-specific parameters being related to the one or more tasks indicated via the instruction, where the second subset of parameters in the second matrix includes the subset of task-specific parameters based on selecting the subset task-specific parameters.

In some examples of the method, apparatus, and non-transitory computer-readable medium described herein, training, via the fine-tuning operation, the adjustable scaling factor, where a balance between the first set of parameters of the pre-trained model and the fine-tuned set of parameters of the fine-tuned model may be based on the training of the adjustable scaling factor.

In some examples of the method, apparatus, and non-transitory computer-readable medium described herein, the adjustable scaling factor may be initialized to a first value prior to training the adjustable scaling factor.

In some examples of the method, apparatus, and non-transitory computer-readable medium described herein, a quantity of parameters within the second subset of parameters that may be trained in accordance with training the second matrix may be based on a rank of the second matrix.

In some examples of the method, apparatus, and non-transitory computer-readable medium described herein, a first function of the input associated with the pre-trained model and the first set of parameter weights, and a second function of the adjustable scaling factor, the input associated with the pre-trained model, and a combination of the set of matrices.

In some examples of the method, apparatus, and non-transitory computer-readable medium described herein, the dropout function may be applied to the second function.

In some examples of the method, apparatus, and non-transitory computer-readable medium described herein, the fine-tuned set of parameter weights of the fine-tuned model may be based on a combination of the first set of parameter weights of the pre-trained model and a function of the adjustable scaling factor and a combination of the set of matrices.

In some examples of the method, apparatus, and non-transitory computer-readable medium described herein, the distribution function for initializing the one or more values of the one or more first matrices randomly initializes the one or more values of the one or more first matrices.

In some examples of the method, apparatus, and non-transitory computer-readable medium described herein, the one or more uninitialized values of the second subset of parameter weights in the second matrix of the set of matrices may be each initialized to a same first value.

In some examples of the method, apparatus, and non-transitory computer-readable medium described herein, the pre-trained model may be a pre-trained large language model (LLM) and the fine-tuned model that may be based on the pre-trained model may be a fine-tuned LLM that may be based on the pre-trained model.

### BRIEF DESCRIPTION OF THE DRAWINGS

FIG. 1 illustrates an example of a computing system that supports tri-matrix low-rank adaptation of artificial intelligence or machine learning models in accordance with aspects of the present disclosure.

FIG. 2 shows an example of a fine-tuning operation schematic that supports tri-matrix low-rank adaptation of artificial intelligence or machine learning models in accordance with aspects of the present disclosure.

FIG. 3 shows an example of a flowchart that supports tri-matrix low-rank adaptation of artificial intelligence or machine learning models in accordance with aspects of the present disclosure.

FIG. 4 shows a block diagram of an apparatus that supports tri-matrix low-rank adaptation of artificial intelligence or machine learning models in accordance with aspects of the present disclosure.

FIG. 5 shows a block diagram of a fine-tuning module that supports tri-matrix low-rank adaptation of artificial intelligence or machine learning models in accordance with aspects of the present disclosure.

FIG. 6 shows a diagram of a system including a device that supports tri-matrix low-rank adaptation of artificial intelligence or machine learning models in accordance with aspects of the present disclosure.

FIG. 7 shows a flowchart illustrating methods that support tri-matrix low-rank adaptation of artificial intelligence or machine learning models in accordance with aspects of the present disclosure.

FIG. 8 shows an example of a node diagram that supports tri-matrix low-rank adaptation of AI/ML models in accordance with aspects of the present disclosure.

### DETAILED DESCRIPTION

Fine-tuning procedures may be crucial in the adaptations of AI/ML models (e.g., large language models (LLMs)), aiming to tailor the model to perform specific tasks or solve specific problems. In some examples, fine-tuning an AI/ML model may involve adjusting weights of a pre-trained model by exposing the weights of the pre-trained model to task-specific data, thereby refining the capabilities of the AI/ML model to understand and respond to queries based on a given context. Fine-tuning procedures may further leverage the foundational knowledge encoded within an AI/ML model while introducing patterns and nuances pertinent to a targeted problem statement. In some examples, AI/ML models, such as LLMs, may be pre-trained on a corpus of input data, which may include text, images, video, audio, structured data, or any combination thereof. Such data may represent general-purpose data, domain-specific data, or any combination thereof. The training data may also include representations of language, such as syntax, semantics, and general world knowledge. These models act as a robust starting point, offering a versatile understanding of language that can be fine-tuned for various downstream tasks, including natural language processing and generation.

In some examples, fine-tuning techniques for LLM s may include full fine-tuning, which involves continued training of a model to specialize the model to perform a specific task, such as sentiment analysis or question answering. While such techniques may be effective, full fine-tuning may be relatively computationally intensive for LLMs. In some examples, to reduce the computational intensity of the fine-tuning procedures, a subset of parameters may be trained or adjusted, a set of parameters may be added for training to reduce the quantity of trainable parameters, or both, thus reducing the overall computational overhead. However, the computational overhead associated with the quantity of parameters being trained in fine-tuning procedures may still be relatively high even when training a subset of parameters.

The techniques of the present disclosure may introduce a tri-matrix low-rank adaptation procedure that utilizes an adaptive scaling mechanism to reduce a quantity of trainable parameters, reduce the computational overhead and complexity, and reduce the latency associated with fine-tuning an AI/ML model, while maintaining relatively high performance levels. In accordance with the techniques of the present disclosure, a system may obtain a pre-trained model that includes a first set of parameters associated with a first set of parameters weights. The system may generate, as part of a fine-tuning procedure and based on obtaining the first set of parameter weights of the pre-trained model, a set of matrices that are indicative of a decomposition of a second set of parameter weights associated with a second set of parameters that are associated with the fine-tuning procedure and are different from the first set of parameters of the pre-trained model. For example, the set of matrices may be indicative of a decomposition of task-specific parameters associated with a task that an AI/ML model is being fine-tuned to perform. The set of matrices may include one or more first matrices that include a respective subset of parameter weights from the second set of parameter weights that are associated with a respective subset of parameters from the second set of parameters. Further, the respective subset of parameter weights corresponding to one or more values initialized in accordance with a distribution function. The set of matrices may also include a second matrix that includes a second subset of parameter weights from the second set of parameter weights that are associated with a second subset of parameters from the second set of parameters. Moreover, the second subset of parameter weights may correspond to one or more uninitialized values. For example, the parameter weights of the second subset of parameter weights may each have a value of 0.

Based on generating the set of matrices, the system may train the second matrix by adjusting the one or more uninitialized values of the second subset of parameter weights associated with the second subset of parameters that correspond to one or more task-specific parameters associated with the fine-tuning operation of the pre-trained model. Further, via the fine-tuning procedure, the system may obtain a fine-tuned model that includes a fine-tuned set of parameters associated with a fine-tuned set of parameter weights. The fine-tuned model may be based on the pre-trained model and may be obtained based on training the second matrix and a function of an input associated with the pre-trained model, the set of parameter weights of the pre-trained model, an adjustable scaling factor, the set of matrices that indicate a decomposition of additional task-specific parameters, and a dropout function. Moreover, in accordance with the techniques of the present disclosure, by generating the set of matrices, training the second matrix, and utilizing the adjustable scaling factor, the tri-matrix low-rank adaptation procedure described herein may reduce the quantity of trainable parameters utilized for the fine-tuning operation relatively significantly while ensuring that the fine-tuned model is associated with a relatively high level of performance. For example, in accordance with the techniques of the present disclosure, the parameters within the one or more first matrices (e.g., a first and a third matrix) may be added to supplement the initial parameters such that the trainable parameters for an AI/ML model are constrained to the additional parameters within the second matrix. Such reduction in the quantity of trainable parameters may further reduce the quantity of computational resources consumed, reduce the latency associated with fine-tuning, and improve the utilization of computational resources by reducing the overall computational overhead associated with fine-tuning a pre-trained model.

In some examples, as part of the tri-matrix low-rank adaptation procedure, the distribution function that initializes the one or more values of the one or more first matrices may randomly initialize the one or more values of the one or more first matrices. Further, the second matrix of the set of matrices may include the only trainable parameters, thus reducing the overhead associated with fine-tuning parameters of a pre-trained model. In some other examples, the adjustable scaling factor may also be trained via the fine-tuning operation and a balance or weight between the set of parameters of the pre-trained model and the fine-tuned set of parameters of the fine-tuned model may be based on the adjustable scaling factor. That is, the adjustable scaling factor may instruct the fine-tuned model how to weight the set of parameters of the pre-trained model versus the fine-tuned set of parameters of the fine-tuned model.

In accordance with the techniques of the present disclosure, the tri-matrix low-rank adaptation procedure may reduce the computational resource overhead and consumption and reduce the latency associated with fine-tuning an AI/ML model while ensuring relatively high levels of performance. Moreover, the techniques of the present disclosure may reduce the quantity of time associated with training or fine-tuning an AI/ML model. For example, by refraining from training any parameters except for task-specific parameters (e.g., the parameters within the second matrix), the techniques of the present disclosure may reduce the quantity of trainable parameters thus reducing the quantity of computational resources that are consumed during the fine-tuning operation. Further, reducing the quantity of computational resources consumed during a fine-tuning operation may improve the overall performance and function of one or more computing components, devices, or systems. For example, since the techniques of the present disclosure may reduce the quantity of computational resources that are consumed, such computing components, devices, or systems may be capable of utilizing the saved computational resources for other purposes such as performing one or more inferences via the fine-tuned AI/ML model. Therefore, the techniques of the present disclosure may increase the computational capabilities of one or more computing components, devices, or systems. That is, by implementing a fine-tuning operation that utilizes a relatively low quantity of trainable parameters and ensures relatively high levels of accuracy, the techniques of the present disclosure may enable one or more computing components, devices, or systems the capability of performing additional actions or functions, which can thus improve the utilization and function of such computing components, devices, or systems.

Aspects of the disclosure are initially described in the context of a computing system. Additional aspects of the disclosure are described in the context of a fine-tuning operation schematic and a flowchart. Aspects of the disclosure are further illustrated by and described with reference to apparatus diagrams, system diagrams, and flowcharts that relate to tri-matrix low-rank adaptation of AI/ML models.

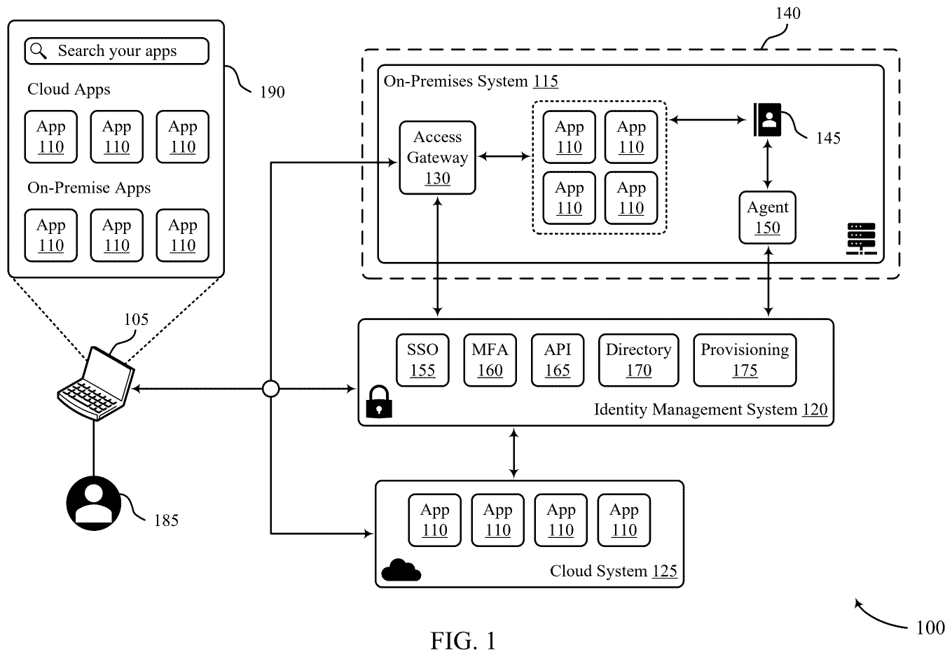

FIG. 1 illustrates an example of a computing system 100 that supports tri-matrix low-rank adaptation of AI/ML models in accordance with various aspects of the present disclosure. The computing system 100 includes a computing device 105 (such as a desktop, laptop, smartphone, tablet, or the like), an on-premises system 115, an identity management system 120, and a cloud system 125, which may communicate with each other via a network, such as a wired network (e.g., the Internet), a wireless network (e.g., a cellular network, a wireless local area network (WLAN)), or both. In some cases, the network may be implemented as a public network, a private network, a secured network, an unsecured network, or any combination thereof. The network may include various communication links, hubs, bridges, routers, switches, ports, or other physical and/or logical network components, which may be distributed across the computing system 100.

The on-premises system 115 (also referred to as an on-premises infrastructure or environment) may be an example of a computing system in which a client organization owns, operates, and maintains its own physical hardware and/or software resources within its own data center(s) and facilities, instead of using cloud-based (e.g., off-site) resources. Thus, in the on-premises system 115, hardware, servers, networking equipment, and other infrastructure components may be physically located within the “premises” of the client organization, which may be protected by a firewall 140 (e.g., a network security device or software application that is configured to monitor, filter, and control incoming/outgoing network traffic). In some examples, users may remotely access or otherwise utilize compute resources of the on-premises system 115, for example, via a virtual private network (VPN).

In contrast, the cloud system 125 (also referred to as a cloud-based infrastructure or environment) may be an example of a system of compute resources (such as servers, databases, virtual machines, containers, and the like) that are hosted and managed by a third-party cloud service provider using third-party data center(s), which can be physically co-located or distributed across multiple geographic regions. The cloud system 125 may offer high scalability and a wide range of managed services, including (but not limited to) database management, analytics, AI/ML, etc. Examples of cloud systems 125 include (AMAZON WEB SERVICES) AWS®, MICROSOFT AZURE®, GOOGLE CLOUD PLATFORM®, ALIBABA CLOUD®, ORACLE® CLOUD INFRASTRUCTURE (OCI), and the like.

The identity management system 120 may support one or more services, such as a single sign-on (SSO) service 155, a multi-factor authentication (MFA) service 160, an application programming interface (API) service 165, a directory management service 170, or a provisioning service 175 for various on-premises applications 110 (e.g., applications 110 running on compute resources of the on-premises system 115) and/or cloud applications 110 (e.g., applications 110 running on compute resources of the cloud system 125), among other examples of services. The SSO service 155, the MFA service 160, the API service 165, the directory management service 170, and/or the provisioning service 175 may be individually or collectively provided (e.g., hosted) by one or more physical machines, virtual machines, physical servers, virtual (e.g., cloud) servers, data centers, or other compute resources managed by or otherwise accessible to the identity management system 120.

A user 185 may interact with the computing device 105 to communicate with one or more of the on-premises system 115, the identity management system 120, or the cloud system 125. For example, the user 185 may access one or more applications 110 by interacting with an interface 190 of the computing device 105. In some implementations, the user 185 may be prompted to provide some form of identification (such as a password, personal identification number (PIN), biometric information, or the like) before the interface 190 is presented to the user 185. In some implementations, the user 185 may be a developer, customer, employee, vendor, partner, or contractor of a client organization (such as a group, business, enterprise, non-profit, or startup that uses one or more services of the identity management system 120). The applications 110 may include one or more on-premises applications 110 (hosted by the on-premises system 115), mobile applications 110 (configured for mobile devices), and/or one or more cloud applications 110 (hosted by the cloud system 125).

The SSO service 155 of the identity management system 120 may allow the user 185 to access multiple applications 110 with one or more credentials. Once authenticated, the user 185 may access one or more of the applications 110 (for example, via the interface 190 of the computing device 105). That is, based on the identity management system 120 authenticating the identity of the user 185, the user 185 may obtain access to multiple applications 110, for example, without having to re-enter the credentials (or enter other credentials). The SSO service 155 may leverage one or more authentication protocols, such as Security Assertion Markup Language (SAML) or OpenID Connect (OIDC), among other examples of authentication protocols. In some examples, the user 185 may attempt to access an application 110 via a browser. In such examples, the browser may be redirected to the SSO service 155 of the identity management system 120, which may serve as the identity provider (IdP). For example, in some implementations, the browser (e.g., the user's request communicated via the browser) may be redirected by an access gateway 130 (e.g., a reverse proxy-based virtual application configured to secure web applications 110 that may not natively support SAML or OIDC).

In some examples, the access gateway 130 may support integrations with legacy applications 110 using hypertext transfer protocol (HTTP) headers and Kerberos tokens, which may offer universal resource locator (URL)-based authorization, among other functionalities. In some examples, such as in response to the user's request, the IdP may prompt the user 185 for one or more credentials (such as a password, PIN, biometric information, or the like) and the user 185 may provide the requested authentication credentials to the IdP. In some implementations, the IdP may leverage the MFA service 160 for added security. The IdP may verify the user's identity by comparing the credentials provided by the user 185 to credentials associated with the user's account. For example, one or more credentials associated with the user's account may be registered with the IdP (e.g., previously registered, or otherwise authorized for authentication of the user's identity via the IdP). The IdP may generate a security token (such as a SAML token or Oath 2.0 token) containing information associated with the identity and/or authentication status of the user 185 based on successful authentication of the user's identity.

The IdP may send the security token to the computing device 105 (e.g., the browser or application 110 running on the computing device 105). In some examples, the application 110 may be associated with a service provider (SP), which may host or manage the application 110. In such examples, the computing device 105 may forward the token to the SP. Accordingly, the SP may verify the authenticity of the token and determine whether the user 185 is authorized to access the requested applications 110. In some examples, such as examples in which the SP determines that the user 185 is authorized to access the requested application, the SP may grant the user 185 access to the requested applications 110, for example, without prompting the user 185 to enter credentials (e.g., without prompting the user to log-in). The SSO service 155 may promote improved user experience (e.g., by limiting the number of credentials the user 185 has to remember/enter), enhanced security (e.g., by leveraging secure authentication protocols and centralized security policies), and reduced credential fatigue, among other benefits.

The MFA service 160 of the identity management system 120 may enhance the security of the computing system 100 by prompting the user 185 to provide multiple authentication factors before granting the user 185 access to applications 110. These authentication factors may include one or more knowledge factors (e.g., something the user 185 knows, such as a password), one or more possession factors (e.g., something the user 185 is in possession of, such as a mobile app-generated code or a hardware token), or one or more inherence factors (e.g., something inherent to the user 185, such as a fingerprint or other biometric information). In some implementations, the MFA service 160 may be used in conjunction with the SSO service 155. For example, the user 185 may provide the requested login credentials to the identity management system 120 in accordance with an SSO flow and, in response, the identity management system 120 may prompt the user 185 to provide a second factor, such as a possession factor (e.g., a one-time passcode (OTP), a hardware token, a text message code, an email link/code). The user 185 may obtain access (e.g., be granted access by the identity management system 120) to the requested applications 110 based on successful verification of both the first authentication factor and the second authentication factor.

The API service 165 of the identity management system 120 can secure APIs by managing access tokens and API keys for various client organizations, which may enable (e.g., only enable) authorized applications (e.g., one or more of the applications 110) and authorized users (e.g., the user 185) to interact with a client organization's APIs. The API service 165 may enable client organizations to implement customizable login experiences that are consistent with their architecture, brand, and security configuration. The API service 165 may enable administrators to control user API access (e.g., whether the user 185 and/or one or more other users have access to one or more particular APIs). In some examples, the API service 165 may enable administrators to control API access for users via authorization policies, such as standards-based authorization policies that leverage OAuth 2.0. The API service 165 may additionally, or alternatively, implement role-based access control (RBAC) for applications 110. In some implementations, the API service 165 can be used to configure user lifecycle policies that automate API onboarding and off-boarding processes.

The directory management service 170 may enable the identity management system 120 to integrate with various identity sources of client organizations. In some implementations, the directory management service 170 may communicate with a directory service 145 of the on-premises system 115 via a software agent 150 installed on one or more computers, servers, and/or devices of the on-premises system 115. Additionally, or alternatively, the directory management service 170 may communicate with one or more other directory services, such as one or more cloud-based directory services. As described herein, a software agent 150 generally refers to a software program or component that operates on a system or device (such as a device of the on-premises system 115) to perform operations or collect data on behalf of another software application or system (such as the identity management system 120).

The provisioning service 175 of the identity management system 120 may support user provisioning and deprovisioning. For example, in response to an employee joining a client organization, the identity management system 120 may automatically create accounts for the employee and provide the employee with access to one or more resources via the accounts. Similarly, in response to the employee (or some other employee) leaving the client organization, the identity management system 120 may autonomously deprovision the employee's accounts and revoke the employee's access to the one or more resources (e.g., with little to no intervention from the client organization). The provisioning service 175 may maintain audit logs and records of user deprovisioning events, which may help the client organization demonstrate compliance and track user lifecycle changes. In some implementations, the provisioning service 175 may enable administrators to map user attributes and roles (e.g., permissions, privileges) between the identity management system 120 and connected applications 110, ensuring that user profiles are consistent across the identity management system 120, the on-premises system 115, and the cloud system 125.

Although not depicted in the example of FIG. 1, a person skilled in the art would appreciate that the identity management system 120 may support or otherwise provide access to any number of additional or alternative services, applications 110, platforms, providers, or the like. In other words, the functionality of the identity management system 120 is not limited to the exemplary components and services mentioned in the preceding description of the computing system 100. The description herein is provided to enable a person skilled in the art to make or use the present disclosure. Various modifications to the present disclosure will be readily apparent to those skilled in the art, and the generic principles defined herein may be applied to other variations without departing from the scope of the present disclosure. Accordingly, the present disclosure is not limited to the examples and designs described herein, but is to be accorded the broadest scope consistent with the principles and novel features disclosed herein.

Certain aspects and techniques as described herein may be implemented, at least in part, AI/ML program, such as a program that includes an AI/ML model or artificial neural network (ANN) model. An example ML model may include mathematical representations or define computing capabilities for making inferences from input data based on patterns or relationships identified in the input data. As used herein, the term “inferences” can include one or more of decisions, predictions, determinations, or values, which may represent outputs of an AI/ML model. The computing capabilities may be defined in terms of respective parameters of the AI/ML model, such as weights and biases. Weights may indicate relationships between respective input data and respective outputs of the AI/ML model, and biases may be offsets added to inputs of the AI/ML model.

In some aspects, an AI/ML model may be configured to assist an IdP, an application 110, an on-premises system 115, an identity management system 120, a cloud system 125, or any combination thereof with identity management and authentications. Such an AI/ML model may be configured with weights and biases to perform identity management and authentication services or related tasks. Thus, during operation of a device, the AI/ML model may receive input data (such as certificates, authentication tokens, authentication responses, API requests and responses) and make inferences (such as whether a user should be granted access to a resources, which resources a user may have access to, and the like) based on the weights and biases.

AI/ML models may be deployed in one or more devices, services, platforms, or any combination thereof (e.g., a computing device 105, the on-premises system 115, the identity management system 120, the cloud system 125, or any combination thereof) and may be configured to enhance various aspects of a computing system 100. For example, an AI/ML model may be trained to identify patterns or relationships in data corresponding to a on-premises system 115, an identity management system 120, a cloud system 125, or an application 110, or any combination thereof. An AI/ML model may support operational decisions relating to one or more aspects associated with applications 110, the on-premises system 115, the identity management system 120, the cloud system 125, or any combination thereof. For example, an ML model may be utilized for supporting or improving aspects such as identity management, authentication, user provisioning and deprovisioning, and the like as described elsewhere herein.

AI/ML models may be characterized in terms of types of learning that generate specific types of learned models that perform specific types of tasks. For example, different types of AI/ML techniques include supervised learning, unsupervised learning, semi-supervised learning, reinforcement learning, and the like. AI/ML models may be used to perform different tasks such as classification or regression, where classification refers to determining one or more discrete output values from a set of predefined output values, and regression refers to determining continuous values which are not bounded by predefined output values. Some example AI/ML models configured for performing such tasks include ANNs such as convolutional neural networks (CNNs) and recurrent neural networks (RNNs), transformers, diffusion models, regression analysis models (such as statistical models), LLMs, decision tree learning (such as predictive models), support vector networks (SVMs), and probabilistic graphical models (such as a Bayesian network), etc.

The description herein illustrates, by way of some examples, how one or more tasks or problems in the computing system 100 may benefit from the application of one or more AI/ML models. To facilitate the discussion, an ML model configured using an ANN is used, but it should be understood, that other types of ML models may be used instead of an ANN. Hence, unless expressly recited, subject matter regarding an ML model is not necessarily intended to be limited to an ANN solution. Further, it should be understood that, unless otherwise specifically stated, terms such “AI/ML model,” “ML model,” “trained ML model,” “ANN,” “model,” “algorithm,” or the like are intended to be interchangeable.

In some examples of the computing system 100, an AI/ML model may be fine-tuned to perform one or more tasks. In accordance with the techniques of the present disclosure, the computing system 100 may perform a tri-matrix low-rank adaptation procedure to fine-tune an AI/ML model. The tri-matrix low-rank adaptation procedure may utilize an adaptive scaling mechanism to reduce the quantity of trainable parameters while maintaining similar performance as other fine-tuning procedures, thus reducing the overall computational overhead, the computational complexity, and the latency associated with fine-tuning an AI/ML model. In accordance with the techniques of the present disclosure, the computing system 100 (e.g., the computing device 105, a applications 110, the on-premises system 115, the identity management system 120, the cloud system 125, or any other component or service of the computing system 100) may obtain a pre-trained model that includes a first set of parameters associated with a first set of parameters weights. The computing system 100 may then generate, as part of a fine-tuning procedure and based on obtaining the first set of parameter weights of the pre-trained model, a set of matrices (e.g., low-rank matrices) that, when multiplied together, form a weight update added to the pre-trained weights. The set of matrices may further indicate a decomposition of a second set of parameter weights associated with a second set of parameters that correspond to the fine-tuning procedure. For example, the second set of parameter weights associated with the second set of parameters may correspond to task-specific parameters that are associated with a task that a model is being fine-tuned to perform. Moreover, the pre-trained weights may be fixed and unadjusted during the fine-tuning procedure. Further, the set of matrices may include one or more first matrices that include a respective subset of parameter weights from a second set of parameter weights that correspond to one or more values initialized in accordance with a distribution function. The set of matrices may also include a second matrix that includes a second subset of parameter weights from the second set of parameter weights that are associated with a second subset of parameters from the second set of parameters. Moreover, the second subset of parameter weights corresponding to one or more uninitialized values.

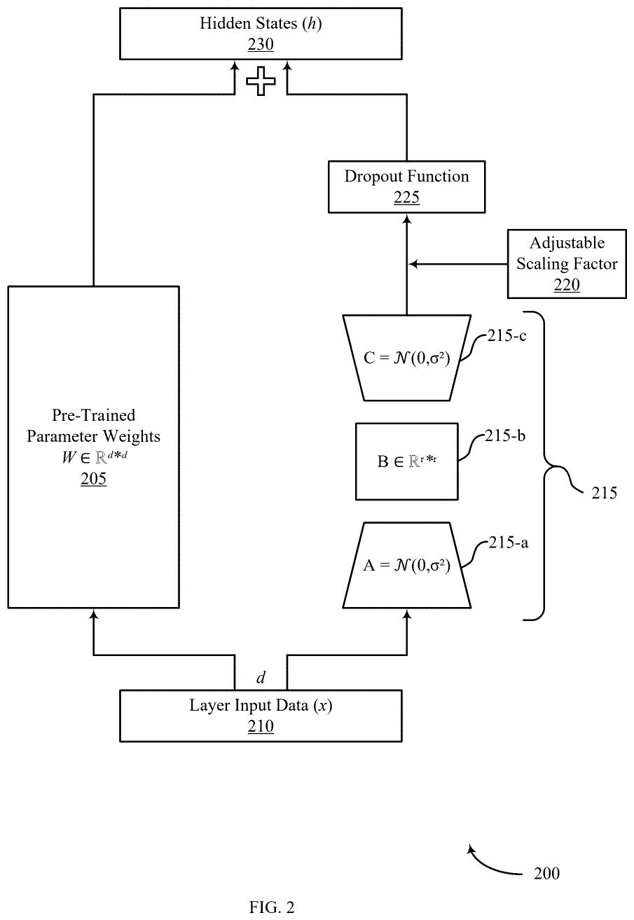

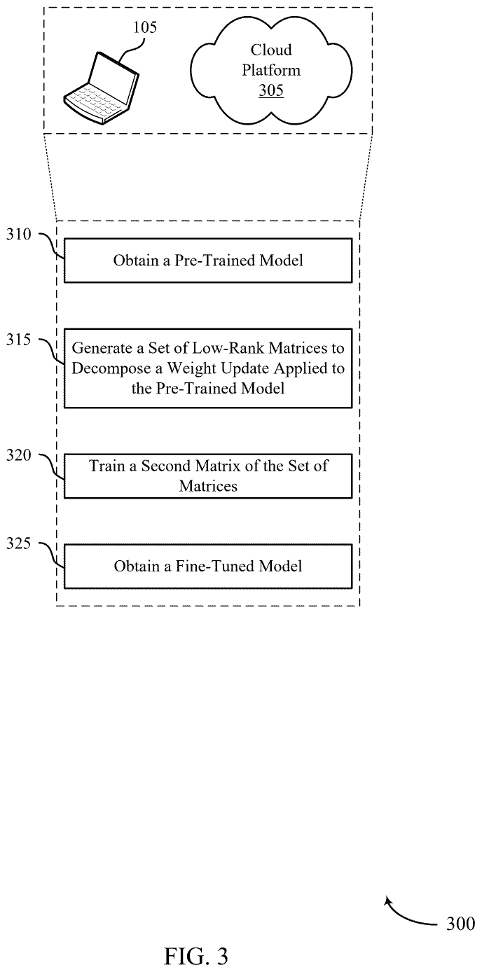

Based on generating the set of matrices, the computing system 100 may train the second matrix by adjusting the one or more uninitialized values of the second subset of parameter weights associated with the second subset of parameters that correspond to one or more task-specific parameters associated with the fine-tuning operation of the pre-trained model. Further, via the fine-tuning procedure, the computing system 100 may obtain a fine-tuned model that includes a fine-tuned set of parameters associated with a fine-tuned set of parameter weights. The fine-tuned model may be based on the pre-trained model and may be obtained based on training the second matrix and a function of an input associated with the pre-trained model, the set of parameter weights of the pre-trained model, an adjustable scaling factor, the set of matrices, and a dropout function. Further descriptions of the computing system 100 fine-tuning an AI/ML model in accordance with the techniques of the present disclosure may described elsewhere herein, such as with reference to FIGS. 2 and 3.

FIG. 2 shows an example of a fine-tuning operation schematic 200 that supports tri-matrix low-rank adaptation of AI/ML models in accordance with aspects of the present disclosure. In some examples, the fine-tuning operation schematic 200 may implement or be implemented by the computing system 100. For example, the fine-tuning operation schematic 200 may illustrate a fine-tuning operation that is performed by corresponding devices, components, services, or platforms described herein with reference to FIG. 1.

In some examples, fine-tuning may be relatively useful in the adaptation of AI/ML models, such as LLM s. For example, fine-tuning operations may assist in training AI/ML models to perform specific tasks or to solve specific problems. In some cases, fine-tuning operations may expose a set of pre-trained parameter weights 205 of a pre-trained model to a set of layer input data 210 to adjust the set of pre-trained parameter weights 205. Moreover, the set of layer input data 210 may represent a set of task-specific data that has been transformed into feature representations through an embedding layer.

In some examples, fine-tuning procedures may be performed by adjusting the set of pre-trained parameter weights 205 using the set of layer input data 210 that can include task-specific data, the fine-tuning operation may improve the capabilities of an AI/ML model to interpret and parse relatively specific tasks and generate responses in a relatively more efficient and accurate fashion. For example, the fine-tuning operations may include introducing additional patterns and nuances that are relevant to a targeted problem statement to train generic AI/ML models. For example, generic AI/ML models may be trained on relatively large corpuses of data to understand language concepts such as syntax, semantics, and general world knowledge. However, such generic AI/ML models may struggle to generate accurate responses to relatively narrow or specific questions. For example, while an AI/ML model may be capable of answering relatively simple questions (e.g., a question such as “why is the sky blue?”), the AI/ML model may be incapable of accurately and efficiently answering or generating a response to a relatively complex question task, or query (e.g., a query that asks the AI/ML model to generate business insights and market predictions based on a set of layer input data).

Therefore, users, systems, platforms, services, and the like may utilize generic AI/ML models as a starting point for fine-tuning operations and may utilize fine-tuning operations to fine-tune generic AI/ML models for various downstream tasks (e.g., natural language understanding and generation). For example, an AI/ML model such as a pre-trained autoregressive language model, P_{θ}(y|x), may be adapted for various downstream tasks by fine-tuning the pre-trained AI/ML model on task-specific data. In some cases, to fine-tune a pre-trained model, a training dataset of context-target pairs, Z={(xᵢ,yᵢ)}_{i=1, . . . , N}, may be utilized where xᵢ may represent a sequence of tokens and yᵢ may represent a sequence of tokens corresponding to an answer generated by the model or a classification task, depending on the task. For example, in a natural language inference task, xᵢ may represent a pair of sentences (e.g., a premise and a hypothesis), and yᵢ may represent a corresponding classification label. Utilizing such data, an AI/ML model (e.g., an LLM) may be updated to improve the performance capabilities of the AI/ML model to perform a respective task.

In some examples, to fine-tune an AI/ML model, each parameter of the AI/ML may be continuously trained with task-specific data to specialize or tune the AI/ML model for a respective task, such as sentiment analysis or question answering. For example, for full fine-tuning, the set of pre-trained parameter weights 205, θ₀, may be updated directly to θ₀+Δθ by maximizing a conditional language modeling objective. In the context of classification tasks where the AI/ML model may be fine-tuned to predict a discrete class label y based on an input sequence x (e.g., the set of layer input data 210), the objective may be represented via Equation 1 below. In Equation 1 below, P_{θ}(y|x) may represent the probability distribution over class labels given the input (e.g., set of layer input data 210), x, to generate an output or label, y, for a set of training data, Z, (e.g., for a set of training data, Z, y may be a label for an input x). Further, θ may represent the full set of model parameters, including the pre-trained model parameters (e.g., parameters associated with the set of pre-trained parameter weights 205), θ₀, and the task-specific updates, Δθ.

$${\sum }_{( x , y ) ∈ Z} log {P}_{θ} ( y \vert x ) \qquad ( 1 )$$

While such techniques of fine-tuning may be relatively effective, continuously retraining an AI/ML model with task-specific data may be relatively computationally intensive. For example, some AI/ML models may have billions of parameters and training each parameter may be relatively time consuming and can result in a relatively large increase in the consumption of computational resources. To reduce the computational intensity of fine-tuning an AI/ML model, rather than updating all the model parameters, a subset of model parameters may be adjusted, a set of parameters may be added to a model for training, or both. Such techniques may reduce the computational overhead of fine-tuning operations while ensuring relatively high performance and accuracy.

In some examples, such techniques of adjusting a subset of parameters or adding additional parameters to a model as trainable parameters rather than (re) training all the parameters of an AI/ML model for a fine-tuning operation may be referred to as Parameter-Efficient Fine-Tuning (PEFT) procedures. PEFT procedures may be characterized into various different categories such as, additive procedure, selective procedures, and re-parameterized procedures. Additive procedures may include introducing additional trainable parameters into an AI/ML model without modifying or adjusting the original parameters of the AI/ML model (e.g., without adjusting the set of pre-trained parameter weights 205). Selective procedures may include fine-tuning a targeted subset of existing parameters of an AI/ML model (e.g., a subset of the set of pre-trained parameter weights 205) to reduce the overall computational cost and to maintain most of the original parameters of the AI/ML model. Re-parameterized procedures may adjust or change how parameters of an AI/ML model are represented. Such procedures may enable relatively more efficient adaptations by embedding task-relevant or task-specific information directly into the modified parameters which can result in relatively higher performance for domain-specific applications while also ensuring that the quantity of trainable parameters is relatively low to ensure low computational costs.

In some cases, a low-rank adaptation procedure, which reparameterizes the weight update into an additive form via low-rank matrices, may be utilized to fine-tune an AI/ML model. In the low-rank adaptation procedure, one or more layers of an AI/ML model, such as dense or attention layers, may be re-parameterized by introducing additional parameters in low-rank matrices that can effectively reduce the dimensionality of the weight updates needed for fine-tuning operations. For example, instead of updating the full set of parameters of an AI/ML model, the low-rank adaptation procedure may learn a low-rank decomposition of parameter updates which can reduce the quantity of trainable parameters while ensuring that the AI/ML model is capable of capturing or learning task-specific nuances. Moreover, the low-rank adaptation techniques for fine-tuning may include training or fine-tuning a relatively small set of task-specific parameters, φ.

In accordance with the techniques of the present disclosure, to further reduce the quantity of trainable parameters while maintaining similar and relatively high levels of performance accuracy, a tri-matrix low-rank adaptation procedure may be utilized to fine-tune an AI/ML model. The tri-matrix low-rank adaptation procedure may utilize an adaptive scaling mechanism to ensure a relatively more flexible and efficient approach for adapting or fine-tuning AI/ML models, such as LLM s, to perform relatively diverse tasks. Moreover, the tri-matrix low-rank adaptation procedure may both maintain the efficiency of the low-rank adaptation procedure and enhance or improve the capability of an AI/ML model to interpret and perform relatively complex tasks.

For example, when utilizing the tri-matrix low-rank adaptation procedures in accordance with the techniques of the present disclosure, rather than updating the set of pre-trained parameter weights 205 associated with the parameters of a pre-trained model, θ₀, the tri-matrix low-rank adaptation procedure may utilize a low-rank update, Δθ_{φ}, that is relatively smaller than the initial or original parameter set, θ₀. For example, the tri-matrix low-rank adaptation procedure may add a relatively small set of additional parameters (e.g., task-specific parameters) via three matrices and may train only one of the three matrices, thus reducing the quantity of trainable parameters for fine-tuning an AI/ML model. Therefore, the objective (e.g., the optimization problem) may be represented via Equation 2 below. In Equation 2 below Δθ_{φ} may represent a task-specific update encoded by φ, and P_{θ}_{₀}_{+Δθ}_{_{φ}}(y|x) may represent the probability distribution over class labels for the adapted model.

$${\sum }_{( x , y ) ∈ Z} log {P}_{{θ}_{0} + Δ {θ}_{ϕ}} ( y \vert x ) \qquad ( 2 )$$

Moreover, similar to low-rank adaptation procedures, when utilizing tri-matrix low-rank adaptation procedures, the update Δθ_{φ} may be represented in a low-rank form to make the adaptation of a respective AI/ML model both memory efficient and computationally efficient. Further, the techniques of the present disclosure may restrict the update to a low-rank representation to ensure that the quantity of learnable parameters, |φ|, is relatively smaller than the size of the original model, θ₀. Therefore, when utilizing the tri-matrix low-rank adaptation procedures, the classification objective may remain the same as in full fine-tuning, but instead of training all of the parameters, θ, a relatively smaller parameter set, φ, which encodes the low-rank adaptation may be trained to reduce the quantity of trainable parameters being utilized for fine-tuning.

In some examples, the tri-matrix low-rank adaptation procedure may be an extension of a low-rank adaptation procedure that utilizes a tri-matrix decomposition to provide relatively more flexible and efficient adaptations of pre-trained AI/ML models (e.g., pre-trained language models) for performing downstream tasks. For example, the low-rank adaptation procedure may add additional task-specific parameters within two matrices and the parameters of both matrices may be the trainable parameters for a fine-tuning operation. However, with the tri-matrix low-rank adaptation procedure described herein in accordance with the techniques of the present disclosure, additional task-specific parameters may be added within three matrices and the parameters of one matrix out of the three matrices may be utilized as the trainable parameters and the other two matrices may remain fixed and unadjusted during a fine-tuning operation. Therefore, while the tri-matrix low-rank adaptation procedure may add relatively more parameters to a model resulting in a relatively higher increase in the quantity of overall parameters of a model compared to the low-rank adaptation procedures, utilizing the tri-matrix structure may enable the capability of only having to train one matrix of parameter weights. Thus, while the quantity of overall parameters of a model may increase when utilizing the tri-matrix low-rank adaptation procedure described herein in accordance with the techniques of the present disclosure, the quantity of trainable parameters may decrease relatively significantly. Moreover, the tri-matrix low-rank adaptation procedures may enable a relatively more granular adaptation of the weights of a model while maintaining a relatively minimal increase in parameters by introducing a set of matrices 215 that include three low-rank matrices (e.g., a matrix 215-a, a matrix 215-b, and a matrix 215-c). Further, the tri-matrix low-rank adaptation procedures may incorporate an adjustable scaling factor 220 (e.g., a trainable scaling factor) to control the magnitude of the low-rank update.

Therefore, as part of a fine-tuning operation and in accordance with the techniques of the present disclosure, a system may generate the set of matrices 215. For example, given an AI/ML model, such as a pre-trained autoregressive language model, with a set of pre-trained parameter weights 205, W₀∈R^{d×k}, a system may compute a weight update, ΔW through a tri-matrix decomposition. In some cases, the update may be decomposed into three low-rank matrices, the matrix 215-a represented as Δ∈R^{k×r}, the matrix 215-b represented as B∈R^{r×r}, and the matrix 215-c represented as C∈R^{r×d}, where r may represent the rank of the decomposition. In some examples, the rank of the decomposition, r, may also be relatively smaller than the dimension of the set of matrices 215, d (e.g., r<<d), to ensure that the quantity of parameters added during the fine-tuning operation (e.g., the adaptation of the AI/ML model) remains relatively small. Further, the set of pre-trained parameter weights 205, W₀, that represents the original weight matrix of the layer of the AI/ML model may remain frozen (e.g., unchanged).

Based on generating the set of matrices 215, the system may then train the matrix 215-b (e.g., the matrix B). In a tri-matrix low-rank adaptation procedure that is in accordance with the techniques of the present disclosure only the matrix 215-b may be trained while the matrix 215-a and the matrix 215-c (e.g., the matrices A and C) may be randomly initialized and fixed (e.g., non-trainable) through the adaptation of the AI/ML model (e.g., the fine-tuning operation) illustrated herein via the fine-tuning operation schematic 200. Such design may leverage the efficiency of low-rank updates while refraining from introducing relatively significant parameter growth. Moreover, the parameter weights of the matrix 215-b may be trained to generate the most accurate response to a given layer input, x, (e.g., the set of layer input data 210) based on randomly initialized values of the matrix 215-a and the matrix 215-c. For example, the matrix 215-a and the matrix 215-c may be initialized in accordance with a distribution function such that the values of the parameter weights associated with the parameters indicated via the matrix 215-a and the matrix 215-c are randomly initialized. In some cases, the distribution function may be an example of a Gaussian distribution, a K aiming Normal distribution, or any other type of distribution function that randomly initializes the values of the parameter weights indicated via the matrix 215-a and the matrix 215-c.

Moreover, the matrix 215-a and the matrix 215-c may remain fixed and random to create a structured and efficient transformation that can improve model flexibility with minimal additional parameters. Further, by making the matrix 215-b trainable, the tri-matrix low-rank adaptation procedure described herein in accordance with the techniques of the present disclosure may allow an AI/ML model to learn a task-specific transformation within a constrained low-rank space defined by the matrix 215-a and the matrix 215-c.

Therefore, the low rank update, as indicated below via Equation 3, may be computed as the product of the matrix 215-a, the matrix 215-b, and the matrix 215-c.

ΔW=ABC (3)

In some examples, the values of the one or more parameter weights associated with the parameters indicated via the matrix 215-b (e.g., the task-specific parameters being trained) may be initialized to 0 after generation of the matrix 215-b. Such initialization may ensure that the low-rank update, ΔW, refrains from contributing any additional transformation at the start of training, allowing an AI/ML model to preserve the pre-trained behaviors of the model. Further, an adapted weight matrix, W_{adapted}, that indicates the weights of the fine-tuned model may be indicated via Equation 4 below as a sum of the original weight matrix (e.g., the set of pre-trained parameter weights 205), W₀, and a product of the low-rank update, ΔW, and the adjustable scaling factor 220, α.

W_{adapted}=W₀+αΔW=W₀+αABC (4)

In some examples, the adjustable scaling factor 220 may control the contribution of the low-rank update. That is, a relatively higher value for the adjustable scaling factor 220 may indicate that the updated parameters are weighted by an AI/ML model relatively more than the original parameters of the AI/ML model (e.g., the set of pre-trained parameter weights 205) and a relatively lower value for the adjustable scaling factor 220 may indicate that the original parameters of the AI/ML model are weighted by the AI/ML model more than the updated parameters. Thus, if the value of the adjustable scaling factor 220 is zero, the adapted weights of an AI/ML model may be the same as the set of pre-trained parameter weights 205 and there may be no effect from a fine-tuning operation. Additionally, or alternatively, the value of the adjustable scaling factor 220 may first be initialized to a value of 1.0 prior to any training to allow a balanced initial contribution of the low-rank update. Such initialization may ensure that the tri-matrix low-rank adaptation procedure can begin training an AI/ML model from a stable configuration and can effectively leverage the representational capacity of the matrix 215-a and the matrix 215-c while dynamically learning task-specific transformations from the matrix 215-b.

In some cases, the adjustable scaling factor 220 may be an example of a trainable parameter that allows an AI/ML model to dynamically adjust the contribution of the low-rank adaptation during training. For example, when utilizing low-rank adaptation procedures α (e.g., the scaling factor) may be determined through a fixed hyperparameter (e.g., a parameter that has a value that is set before training of an AI/ML model, is used to assist controlling the training, and is unable to be learned from training data). In accordance with the techniques of the present disclosure, when utilizing a tri-matrix low-rank adaptation procedure, α may be learned during training. Thus, the AI/ML model may be capable of adjusting a strength of the low-rank update dynamically. Additionally, or alternatively, the adjustable scaling factor 220 may enable an AI/ML model to fine-tune a balance between preserving the pre-trained knowledge of a pre-trained model and incorporating task-specific adaptations. For example, during training, the adjustable scaling factor 220 may be adjusted through gradient descent along with other model parameters. In some examples, gradient descent may be an iterative procedure that adjusts the value of a parameter by executing steps proportional to a negative gradient of a loss function, effectively “descending” toward parameter values that minimize prediction errors. For example, the adjustable scaling factor 220 may be trained via gradient descent by computing how relatively small changes to the adjustable scaling factor 220 can affect an overall loss and then incrementally adjusting the value of the adjustable scaling factor in a direction that reduces error (e.g., increasing the value when a low-rank contribution is relatively too weak or decreasing the value when the low-rank contribution is relatively detrimental the prediction capabilities of a base model).

Therefore, in accordance with the techniques of the present disclosure, by learning the adjustable scaling factor 220 for a target layer, a tri-matrix low-rank adaptation procedure may be capable of flexibly controlling the strength of the low-rank update, thus enabling relatively more precise adaptation to specific tasks without introducing relatively excessive complexity. As such, introducing the tri-matrix structure of the task-specific parameters, refraining from training all the parameters in the three low-rank matrices added, utilization of the adjustable scaling factor 220, or any combination thereof may ensure that the computational complexity and resource consumption levels associated with a fine-tuning operation remain relatively low. Moreover, by ensuring relatively low computational complexity and resource consumption levels, systems, devices, components of devices, or any combination thereof may gain the capability to perform additional tasks due to reduced latency from the reduced complexity and resource consumption, thus improving the overall function of such systems, devices, components of devices, or any combination thereof.

Moreover, in accordance the techniques of the present disclosure, in the forward pass (e.g., a training phase) of the tri-matrix low-rank adaptation layer, a layer input (e.g., the set of layer input data 210), x∈R^{d}, may be passed through the original pre-trained linear transformation represented by W₀ (e.g., the set of pre-trained parameter weights 205), as indicated via Equation 5 below.

h₀=W₀x (5)

In Equation 5, x may represent the set of layer input data 210 (e.g., a token embedding) and h₀, where h₀∈R^{d}, may represent the output of the standard linear transformation. In some examples, the set of layer input data 210, x, may represent a transformed layer input of task-specific training data for a fine-tuning operation. For example, the set of layer input data 210 may be indicative of syslog data, system data, internal question and answer data, or the like that is encoded numerically through embeddings. Further, h₀ may represent the computation of the hidden states of an AI/ML model that is utilizing the set of pre-trained parameter weights 205. Hidden states of an AI/ML model may be internal representations that can indicate and store information associated with previous inputs, allowing the AI/ML model to maintain context and memory across sequential queries or operations of the AI/ML model. That is, in a pre-trained AI/ML model, the output of the standard linear transformation, h₀, may represent the hidden state that encodes learned representations of input data (e.g., the set of layer input data 210), transforming raw features into a higher-dimensional space where semantic relationships and patterns relevant to the training objectives of an AI/ML model that are mathematically expressed before being passed to subsequent layers for further processing or prediction.

Further, to compute a low rank adaptation, Δh, the set of layer input data 210 may be multiplied by the tri-matrix decomposition (e.g., the combination of the matrix 215-a, the matrix 215-b, and the matrix 215-c) and such product may be multiplied by the adjustable scaling factor 220 as indicated via Equation 6 below.

Δh=α*(xABC) (6)

Based on computing the low-rank adaptation or update, a dropout function 225 may be applied to regularize the model as indicated via Equation 7 below. In some examples, the dropout function 225 may be an example of a regularization technique that randomly deactivates one or more parameters or data elements during training, thus creating different network architectures for each training iteration. Applying the dropout function 225 may help regularize the model by preventing co-adaptation of parameters thus reducing overfitting by forcing a network to develop features that refrain from relying on specific parameter combinations, therefore improving the capabilities of an AI/ML to generalize unseen data.

Δh_{dropout}=Dropout(Δh) (7)

Thus, in accordance with the techniques of the present disclosure, the final output of the tri-matrix low-rank adaptation layer may be indicated via Equation 8 below and represented as the sum of the standard linear transformation and the low-rank update with dropout.

h=h₀+Δh_{dropout}=W₀x+a*(xABC) (8)

In some examples, the final output may be representative of the hidden states 230, h, of an AI/ML model. That is, the value of h may represent the computations of the hidden states 230 before going to a task-specific head. In some cases, the task-specific may be related to the task that the fine-tuning operation is fine-tuning an AI/ML model to perform. For example, if the task is summarization of syslog data to determine whether any unauthorized accesses occurred, the task-specific head may be associated with summarizing the syslog data and the hidden states 230 may be indicative of one or more computations performed on the syslog data prior to the summarization.

In accordance with the techniques of the present disclosure, utilizing the tri-matrix low-rank adaptation procedures may result in a relatively significant trainable parameter reduction compared to other fine-tuning operations, such as low-rank adaptation procedures, while maintaining relatively similar adaptation capacity. For example, with an AI/ML model that has 355 million parameters, full fine-tuning may result in retraining all 355 million parameters that can introduce a relatively high computational burden and storage cost (e.g., the quantity of trainable parameters for full fine-tuning operations may be equal to the quantity of overall parameters of a model). Further, utilizing a low-rank adaptation procedure for a fine-tuning operation may result in a reduction of trainable parameters by introducing only low-rank matrices of rank. r, where a quantity of trainable parameters may be proportional to r. For example, with r=8, a low-rank adaptation procedure may expect (e.g., require) 786,432 trainable parameters, and such quantity may increase with the increase in r, reaching 3,145,728 trainable parameters for r=32. While such quantities of trainable parameters may still be relatively high, training 3 million parameters rather than 300 million parameters may result in a relatively significant reduction in computational complexity, resource consumption, and latency.

Further, the techniques of the present disclosure may further reduce the trainable parameter by utilizing the tri-matrix low-rank adaptation procedure that leverages atri-matrix decomposition where the parameters of a single added low-rank matrix (e.g., the matrix 215-b) are trained as the trainable parameters. For example, utilizing the tri-matrix low-rank adaptation procedure may result in 3,120 trainable parameters at r=8, thus resulting in a 252 times reduction in trainable parameters compared to full fine-tuning. Moreover, as the value of r increases, utilizing the tri-matrix low-rank adaptation procedure may result in relatively substantial trainable parameter reductions over utilizing a low-rank adaptation procedure where two low-rank matrices of parameters are added and are both utilized as trainable parameters. For example, utilizing the tri-matrix low-rank adaptation procedure may result in a 128 times reduction at r=16 and a 64 times reduction at r=32 over utilizing a low-rank adaptation procedure where all the parameters in the added low-rank matrices are included as trainable parameters. That is, when r=32, utilizing full fine-tuning may result in 355 million trainable parameters, utilizing the low-rank adaptation procedure (e.g., a low-rank adaptation procedure with two low-rank matrices trained) may result in 3,145,728 trainable parameters, and utilizing the tri-matrix low-rank adaptation procedure (e.g., a version of a low-rank adaptation procedure with three low-rank matrices added and a single matrix trained) may result in 49,200 trainable parameters. Therefore, the techniques of the present disclosure may provide a relatively large decrease in the quantity of trainable parameters for a fine-tuning operation based on utilization of a tri-matrix low-rank adaptation procedure. Additionally, or alternatively, the tri-matrix low-rank adaptation procedure may provide enhanced memory efficiency and can enable scalability for relatively large AI/ML models that may operate on parameter-constricted hardware.

Moreover, in accordance with the techniques of the present disclosure, utilizing incorporation of a learnable, layer-specific scaling factor (e.g., the adjustable scaling factor 220) into the tri-matrix low-rank adaptation procedure may enable an AI/ML to dynamically adjust the contribution of the low-rank update at each layer. Further, the adjustable scaling factor 220 may enhance the flexibility of an AI/ML model by enabling the AI/ML model to vary the influence of the low-rank transformation in each layer based on respective demands or requirements of a task. Such added flexibility along with (e.g., combined with) the tri-matrix structure may enable AI/ML models to efficiently capture complex input interactions and may enable fine-grained control of the adaptation strength through a network. Moreover, by dynamically adjusting the influence of the low-rank components, the tri-matrix low-rank adaptation procedure may provide an effective balance between parameter efficiency and expressive power. Therefore, the techniques of the present disclosure may be relatively well-suited for parameter-constrained applications while preserving adaptation quality across a range of natural language processing tasks.

To perform the fine-tuning operation in accordance with the techniques of the present disclosure, a system may apply the tri-matrix low-rank adaptation procedure to one or more layers of an AI/ML model. For example, the system may target linear layers associated with attention mechanisms as such layers may be relatively important for task adaptations. For example, with a bidirectional encoder model that is configured for language understanding tasks, the model may be structured with stacked transformer encoder layers and a system may target the linear layers within attention submodules and the output projection layers. The attention submodules and the output projection layers may be targeted due to them having a central role in the capabilities of the model to obtain (e.g., capture) semantic relationships between tokens. Such projections may be relatively important for learning the relationships between a query and value vectors in the attention mechanism. Moreover, for each respective task, a system may perform a fine-tuning tri-matrix low-rank adaptation procedure. For example, a system may augment the low-rank updates by introducing an additional very-low-rank matrix into the set of matrices 215 and the adjustable scaling factor 220 to allow for a relatively more flexible low-rank approximation of the parameter updates. Such extension may further improve the performance of an AI/ML model while refraining from introducing a relatively significant increase in the quantity of trainable parameters.

Additionally, or alternatively, the tri-matrix low-rank adaptation procedure may be capable of maintaining similar performance to other low-rank adaptation procedures even with utilizing the modified and parameter-efficient architecture of the tri-matrix low-rank adaptation procedure. For example, initializing the matrix 215-a and the matrix 215-c randomly may allow the matrix 215-a and the matrix 215-c to relatively effectively obtain diverse input-output interactions while remaining fixed through training. Moreover, the weight distribution of the matrix 215-b post-training may resemble a Gaussian pattern indicating that the training results in learning a structure aligned with task-specific representations.

For example, at the start of training, the layer norms of tri-matrix low-rank adaptation parameters for both query and value matrices may be close to zero, aligning with the initial zero-initialization of the matrix 215-b. Such zero starting point may ensure that tri-matrix low-rank adaptation procedure begins with relatively minimal influence on the fine-tuned outputs of an AI/ML model, allowing for a relatively smooth and gradual adaptation to the target task as training progresses.

As training advances, the layer norms may increase, but the growth rates may vary relatively significantly across layers. Such variation may indicate that the query of each respective layer and value projections can adapt differently, likely reflecting the differential relevance of specific layers to the given task. For example, the increase in the norm values of a respective layer with training may indicate that the tri-matrix low-rank adaptation procedure may be progressively capturing task-specific information, with the parameters of each layer contributing to a learned adaptation in the low-rank subspace. Such dynamic growth in the layer norms may thus indicate that the tri-matrix low-rank adaptation procedure can relatively efficiently leverage the matrix 215-b that is associated with minimal training to encode essential adaptations without excessive parameter overhead. Moreover, such pattern observed may indicate that the tri-matrix low-rank adaptation procedure is capable of effectively engaging in layer-wise task-specific learning and adapting the low-rank representations as needed for each layer while maintaining efficient parameter utilization.

In some examples, as training progresses, some layers show a significant increase in scaling values, while others decrease, reflecting a dynamic, adaptive adjustment based on the contribution of each layer to task performance. Further, within each layer, scaling factors may differ between the query (q) and value (v) matrices, thus indicating that the tri-matrix low-rank adaptation procedure is capable of refining an adaptation granularity to capture the unique functional roles of q and v within each layer. In some cases, such learned variability in scaling factors may be a relatively crucial component of the adaptation mechanism for the tri-matrix low-rank adaptation procedure. For example, by allowing scaling factors to adjust independently across layers and between q and v, the tri-matrix low-rank adaptation procedure may dynamically modulate the influence of low-rank updates, enhancing the ability of an AI/ML model to capture task-specific nuances without disrupting pre-trained knowledge. In some cases, higher scaling factors in at least some layers, for instance, may indicate that such layers expect more pronounced adaptations, which the tri-matrix low-rank adaptation procedure can accommodate by increasing the influence of the low-rank component in those areas. Additionally, or alternatively, reduced scaling factors in other layers may indicate that relatively minimal alteration is necessary, enabling the tri-matrix low-rank adaptation procedure to selectively constrain changes where the pre-trained parameters may already be well-aligned with the task.

Such layer-wise adaptability and component-wise adaptability may indicate the capacity for the tri-matrix low-rank adaptation procedure to provide flexible, fine-grained adjustments, allowing a model to engage in task-specific tuning without excessive parameter growth. Moreover, the learned scaling factors may thus act as a refined control mechanism, improving the performance of the integration of the low-rank components of the tri-matrix low-rank adaptation procedure and contributing to the effectiveness as an efficient and expressive fine-tuning approach. Additionally, or alternatively, due to the adaptability of the matrix 215-b by responding layer by layer to task-specific expectations while leveraging the stable structures provided by the matrix 215-a and the matrix 215-c. The alignment between scaling factors and layer normalization values further indicates the ability of the tri-matrix low-rank adaptation procedure to target specific layers for adaptation intensity, enhancing both the flexibility and efficiency in fine-tuning transformer models.

Therefore, the techniques of the present disclosure may introduce the tri-matrix low-rank adaptation procedure that is capable of providing relatively high levels of performance with relatively low quantities of trainable parameters compared to other fine-tuning procedures (e.g., full fine-tuning, other low-rank adaptation procedures, and the like). Moreover, the introduction of the tri-matrix low-rank adaptation procedure may enable systems to determine a balance between computational efficiency and adaptation flexibility. Further, the tri-matrix low-rank adaptation procedure may enable effective model fine-tuning with a minimal increase in parameters thus ensuring relatively efficient adaptations while maintaining the core functionality of an original or base model. Further descriptions of the tri-matrix low-rank adaptation procedure may be described elsewhere herein, such as with reference to FIG. 3.

FIG. 3 shows an example of a flowchart 300 that supports tri-matrix low-rank adaptation of AI/ML models in accordance with aspects of the present disclosure. In some examples, the flowchart 300 may implement or be implemented by computing system 100, the fine-tuning operation schematic 200, or both. For example, the operations of the flowchart 300 may be implemented by a computing device 105, a cloud platform 305, or both which may be examples of devices, services, platforms, or the like described herein with reference to FIGS. 1 and 2.

In the following description of the flowchart 300, the operations may be performed in different orders or at different times. Some operations may also be left out of the flowchart 300, or other operations may be added. Although the computing device 105 and the cloud platform 305 are shown performing the operations of the flowchart 300, some aspects of some operations may also be performed by one or more other devices, services, platforms.

At 310, the computing device 105, the cloud platform 305, or both, may obtain a pre-trained model that includes a first set of parameters associated with a first set of parameter weights (e.g., W₀). In some examples, the computing device 105, the cloud platform 305, or both may obtain an indication of an instruction to perform a fine-tuning operation, where the instruction may include an indication of one or more tasks. Further, the pre-trained model may be an example of a pre-trained LLM.

At 315, the computing device 105, the cloud platform 305, or both may generate, as part of a fine-tuning operation associated with fine-tuning the pre-trained model and based on obtaining the first set of parameter weights, a set of matrices that are indicative of a decomposition of a second set of parameter weights associated with a second set of parameters that include task-specific parameters and are different from the first set of parameters of the pre-trained model. The set of matrices may include one or more first matrices (e.g., the matrix A and the matrix C described with reference to FIG. 2) that include a respective subset of parameter weights from the second set of parameter weights that are associated with a respective subset of parameters from the second set of parameters, where the respective subset of parameter weights may correspond to one or more values initialized in accordance with a distribution function. The set of matrices may also include a second matrix (e.g., the matrix B described with reference to FIG. 2) that includes a second subset of parameter weights from the second set of parameter weights that are associated with a second subset of parameters from the second set of parameters, where the second subset of parameter weights may correspond to one or more uninitialized values (e.g., a value of 0). In some examples, the computing device 105, the cloud platform 305, or both may select, from the set of parameters of the pre-trained model, the one or more task-specific parameters to train via the fine-tuning operation based on the one or more task-specific parameters being related to the one or more tasks indicated via the instruction, where the second subset of parameters in the second matrix may include the one or more task-specific parameters based on selecting the one or more task-specific parameters. Moreover, each matrix of the set of matrices may include parameter weights of task-specific parameters and a subset of parameter weights of the parameter weights of the task-specific parameters may be selected for training while the remainder of the parameter weights of the task-specific parameters may be randomly initialized via a distribution function. In some cases, the distribution function for initializing the one or more values of the one or more first matrices may be a distribution that randomly initializes the one or more values of the one or more first matrices. Additionally, or alternatively, the one or more uninitialized values of the second subset of parameter weights in the second matrix of the set of matrices may each be initialized to a same first value (e.g., a value of 0).

At 320, the computing device 105, the cloud platform 305, or both may train the second matrix by adjusting the one or more uninitialized values of the second subset of parameter weights associated with the second subset of parameters. Moreover, the second subset of parameters may correspond to one or more task-specific parameters associated with the fine-tuning operation of the pre-trained model. In some examples, the computing device 105, the cloud platform 305, or both may also train, via the fine-tuning operation, an adjustable scaling factor (e.g., α), where a balance between the first set of parameters of the pre-trained model and the fine-tuned set of parameters of the fine-tuned model may be based on the training of the adjustable scaling factor. In some cases, the adjustable scaling factor may also be initialized to a first value (e.g., a value of 1.0) prior to training the adjustable scaling factor. Additionally, or alternatively, a quantity of parameters within the second subset of parameters that are trained in accordance with training the second matrix may be based on a rank (e.g., r) of the second matrix.

At 325, the computing device 105 may obtain, via the fine-tuning operation, a fine-tuned model comprising a fine-tuned set of parameters (e.g., W_{adapted} as described with reference to FIG. 2) associated with a fine-tuned set of parameter weights, where the fine-tuned model may be based on the pre-trained model. The fine-tuned model may be obtained based on training the second matrix and a function (e.g., Equation 7 described with reference to FIG. 2) of an input (e.g., x) associated with the pre-trained model, the set of parameter weights of the pre-trained model (e.g., W₀), an adjustable scaling factor (e.g., α), the set of matrices (e.g., the matrices A, B, and C that are a decomposition of the second set of parameters that are task-specific parameters), and a dropout function. In some examples, the function for obtaining the fine-tuned model may be based on a first function of the input associated with the pre-trained model and the set of parameter weights of the pre-trained model (e.g., W₀x), and a second function of the adjustable scaling factor, the input associated with the pre-trained model, and a combination of the set of matrices (e.g., α*(xABC)). Further, in some cases, the dropout function may be applied to the second function. Additionally, or alternatively, the fine-tuned set of parameter weights of the fine-tuned model may be based on a combination of the first set of parameter weights of the pre-trained model and a function of the adjustable scaling factor and a combination of the set of matrices (e.g., Equation 4 described with reference to FIG. 2). In some cases, the fine-tuned model that is based on the pre-trained model may be a fine-tuned LLM that is based on the pre-trained model.

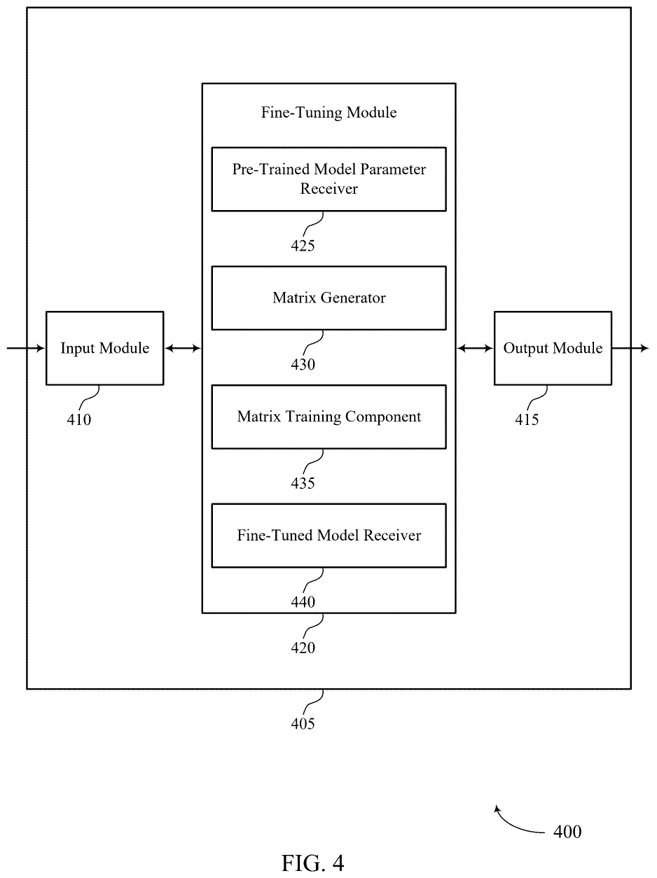

FIG. 4 shows a block diagram 400 of a device 405 that supports tri-matrix low-rank adaptation of artificial intelligence or machine learning models in accordance with aspects of the present disclosure. The device 405 may include an input module 410, an output module 415, and a fine-tuning module 420. The device 405, or one of more components of the device 405 (e.g., the input module 410, the output module 415, the fine-tuning module 420), may include at least one processor, which may be coupled with at least one memory, to support the described techniques. Each of these components may be in communication with one another (e.g., via one or more buses).

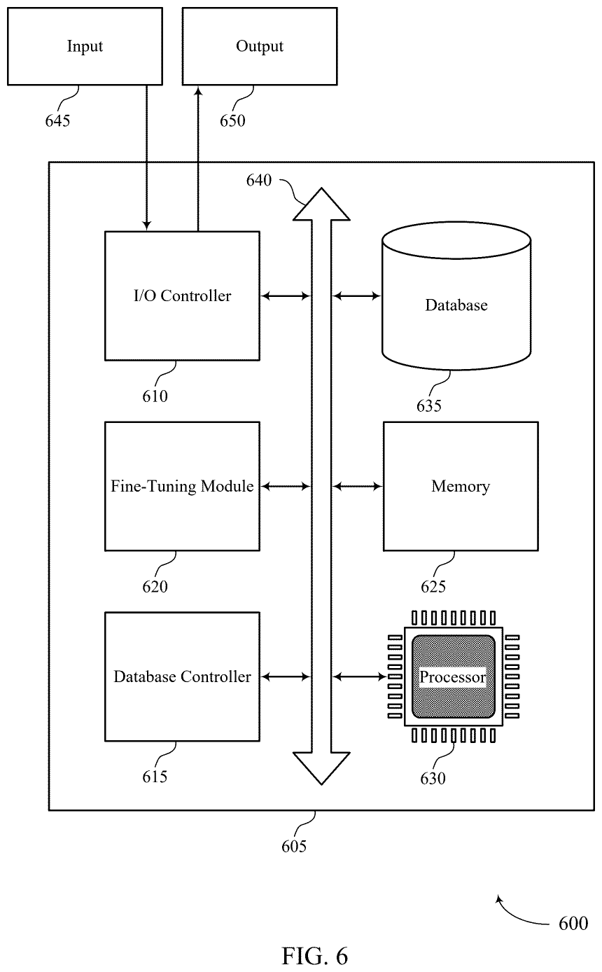

The input module 410 may manage input signals for the device 405. For example, the input module 410 may identify input signals based on an interaction with a modem, a keyboard, a mouse, a touchscreen, or a similar device. These input signals may be associated with user input or processing at other components or devices. In some cases, the input module 410 may utilize an operating system such as iOS®, ANDROID®, MS-DOS®, MS-WINDOWS®, OS/2®, UNIX®, LINUX®, or another known operating system to handle input signals. The input module 410 may send aspects of these input signals to other components of the device 405 for processing. For example, the input module 410 may transmit input signals to the fine-tuning module 420 to support tri-matrix low-rank adaptation of artificial intelligence or machine learning models. In some cases, the input module 410 may be a component of an input/output (I/O) controller 610 as described with reference to FIG. 6.

The output module 415 may manage output signals for the device 405. For example, the output module 415 may receive signals from other components of the device 405, such as the fine-tuning module 420, and may transmit these signals to other components or devices. In some examples, the output module 415 may transmit output signals for display in a user interface, for storage in a database or data store, for further processing at a server or server cluster, or for any other processes at any number of devices or systems. In some cases, the output module 415 may be a component of an I/O controller 610 as described with reference to FIG. 6.

For example, the fine-tuning module 420 may include a pre-trained model parameters receiver 425, a matrix generator 430, a matrix training component 435, a fine-tuned model receiver 440, or any combination thereof. In some examples, the fine-tuning module 420, or various components thereof, may be configured to perform various operations (e.g., receiving, monitoring, transmitting) using or otherwise in cooperation with the input module 410, the output module 415, or both. For example, the fine-tuning module 420 may receive information from the input module 410, send information to the output module 415, or be integrated in combination with the input module 410, the output module 415, or both to receive information, transmit information, or perform various other operations as described herein.

The fine-tuning module 420 may support fine-tuning an AI/ML model in accordance with examples as disclosed herein. The pre-trained model parameters receiver 425 may be configured to support obtaining a pre-trained model including a first set of parameters associated with a first set of parameter weights. The matrix generator 430 may be configured to support generating, as part of a fine-tuning operation associated with fine-tuning the pre-trained model and based on obtaining the first set of parameter weights, a set of matrices that are indicative of a decomposition of a second set of parameter weights associated with a second set of parameters including one or more task-specific parameters for the fine-tuning operation that are different from the first set of parameters, the set of matrices including: one or more first matrices that include a respective first subset of parameter weights from the second set of parameter weights that are associated with a respective first subset of parameters from the second set of parameters, the respective first subset of parameter weights corresponding to one or more values initialized in accordance with a distribution function, and a second matrix that includes a second subset of parameter weights from the second set of parameter weights that are associated with a second subset of parameters from the second set of parameters, the second subset of parameter weights corresponding to one or more uninitialized values. The matrix training component 435 may be configured to support training the second matrix by adjusting the one or more uninitialized values of the second subset of parameter weights associated with the second subset of parameters. The fine-tuned model receiver 440 may be configured to support obtaining, via the fine-tuning operation, a fine-tuned model including a fine-tuned set of parameters associated with a fine-tuned set of parameter weights, the fine-tuned model being based on the pre-trained model, where the fine-tuned model is obtained based on training the second matrix and a function of an input associated with the pre-trained model, the first set of parameter weights, an adjustable scaling factor, the set of matrices including the decomposition of the second set of parameter weights associated with the second set of parameters, and a dropout function.

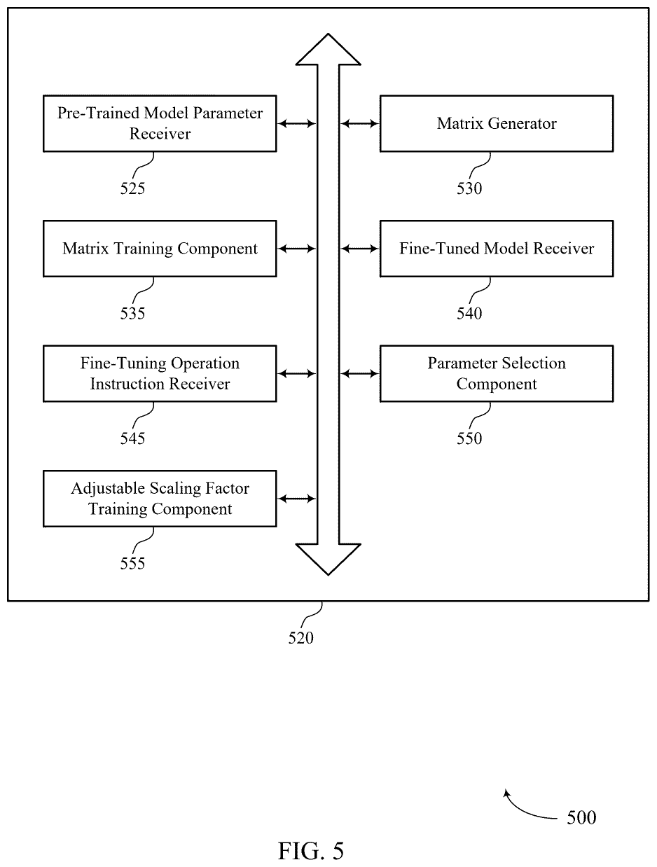

FIG. 5 shows a block diagram 500 of a fine-tuning module 520 that supports tri-matrix low-rank adaptation of artificial intelligence or machine learning models in accordance with aspects of the present disclosure. The fine-tuning module 520 may be an example of aspects of a fine-tuning module or a fine-tuning module 420, or both, as described herein. The fine-tuning module 520, or various components thereof, may be an example of means for performing (e.g., to cause the fine-tuning module 520 to perform) various aspects of tri-matrix low-rank adaptation of artificial intelligence or machine learning models as described herein. For example, the fine-tuning module 520 may include a pre-trained model parameters receiver 525, a matrix generator 530, a matrix training component 535, a fine-tuned model receiver 540, a fine-tuning operation instruction receiver 545, a parameter selection component 550, an adjustable scaling factor training component 555, or any combination thereof. Each of these components, or components of subcomponents thereof (e.g., one or more processors, one or more memories), may communicate, directly or indirectly, with one another (e.g., via one or more buses).

The fine-tuning module 520 may support fine-tuning an AI/ML model in accordance with examples as disclosed herein. The pre-trained model parameters receiver 525 may be configured to support obtaining a pre-trained model including a first set of parameters associated with a first set of parameter weights. The matrix generator 530 may be configured to support generating, as part of a fine-tuning operation associated with fine-tuning the pre-trained model and based on obtaining the first set of parameter weights, a set of matrices that are indicative of a decomposition of a second set of parameter weights associated with a second set of parameters including one or more task-specific parameters for the fine-tuning operation that are different from the first set of parameters, the set of matrices including: one or more first matrices that include a respective first subset of parameter weights from the second set of parameter weights that are associated with a respective first subset of parameters from the second set of parameters, the respective first subset of parameter weights corresponding to one or more values initialized in accordance with a distribution function, and a second matrix that includes a second subset of parameter weights from the second set of parameter weights that are associated with a second subset of parameters from the second set of parameters, the second subset of parameter weights corresponding to one or more uninitialized values. The matrix training component 535 may be configured to support training the second matrix by adjusting the one or more uninitialized values of the second subset of parameter weights associated with the second subset of parameters. The fine-tuned model receiver 540 may be configured to support obtaining, via the fine-tuning operation, a fine-tuned model including a fine-tuned set of parameters associated with a fine-tuned set of parameter weights, the fine-tuned model being based on the pre-trained model, where the fine-tuned model is obtained based on training the second matrix and a function of an input associated with the pre-trained model, the first set of parameter weights, an adjustable scaling factor, the set of matrices including the decomposition of the second set of parameter weights associated with the second set of parameters, and a dropout function.

In some examples, the fine-tuning operation instruction receiver 545 may be configured to support obtaining an indication of an instruction to perform the fine-tuning operation, the instruction including an indication of one or more tasks. In some examples, the parameter selection component 550 may be configured to support selecting, from the second set of parameters, a subset of task-specific parameters to train via the fine-tuning operation based on the subset of task-specific parameters being related to the one or more tasks indicated via the instruction, where the second subset of parameters in the second matrix includes the subset of task-specific parameters based on selecting the subset task-specific parameters.

In some examples, the adjustable scaling factor training component 555 may be configured to support training, via the fine-tuning operation, the adjustable scaling factor, where a balance between the first set of parameters of the pre-trained model and the fine-tuned set of parameters of the fine-tuned model is based on the training of the adjustable scaling factor.

In some examples, the adjustable scaling factor is initialized to a first value prior to training the adjustable scaling factor.

In some examples, a quantity of parameters within the second subset of parameters that are trained in accordance with training the second matrix is based on a rank of the second matrix.

In some examples, a first function of the input associated with the pre-trained model and the first set of parameter weights, and a second function of the adjustable scaling factor, the input associated with the pre-trained model, and a combination of the set of matrices.

In some examples, the dropout function is applied to the second function.

In some examples, the fine-tuned set of parameter weights of the fine-tuned model is based on a combination of the first set of parameter weights of the pre-trained model and a function of the adjustable scaling factor and a combination of the set of matrices.

In some examples, the distribution function for initializing the one or more values of the one or more first matrices randomly initializes the one or more values of the one or more first matrices.

In some examples, the one or more uninitialized values of the second subset of parameter weights in the second matrix of the set of matrices are each initialized to a same first value.

In some examples, the pre-trained model is a pre-trained LLM and the fine-tuned model that is based on the pre-trained model is a fine-tuned LLM that is based on the pre-trained model.

FIG. 6 shows a diagram of a system 600 including a device 605 that supports tri-matrix low-rank adaptation of artificial intelligence or machine learning models in accordance with aspects of the present disclosure. The device 605 may be an example of or include components of a device 405 as described herein. The device 605 may include components for bi-directional voice and data communications including components for transmitting and receiving communications, such as a fine-tuning module 620, an I/O controller, such as an I/O controller 610, a database controller 615, at least one memory 625, at least one processor 630, and a database 635. These components may be in electronic communication or otherwise coupled (e.g., operatively, communicatively, functionally, electronically, electrically) via one or more buses (e.g., a bus 640).

The I/O controller 610 may manage input signals 645 and output signals 650 for the device 605. The I/O controller 610 may also manage peripherals not integrated into the device 605. In some cases, the I/O controller 610 may represent a physical connection or port to an external peripheral. In some cases, the I/O controller 610 may utilize an operating system such as iOS®, ANDROID®, MS-DOS®, MS-WINDOWS®, OS/2®, UNIX®, LINUX®, or another known operating system. In other cases, the I/O controller 610 may represent or interact with a modem, a keyboard, a mouse, a touchscreen, or a similar device. In some cases, the I/O controller 610 may be implemented as part of a processor 630. In some examples, a user may interact with the device 605 via the I/O controller 610 or via hardware components controlled by the I/O controller 610.

The database controller 615 may manage data storage and processing in a database 635. In some cases, a user may interact with the database controller 615. In other cases, the database controller 615 may operate automatically without user interaction. The database 635 may be an example of a single database, a distributed database, multiple distributed databases, a data store, a data lake, or an emergency backup database.

Memory 625 may include random-access memory (RAM) and read-only memory (ROM). The memory 625 may store computer-readable, computer-executable software including instructions that, when executed, cause at least one processor 630 to perform various functions described herein. In some cases, the memory 625 may contain, among other things, a basic I/O system (BIOS) which may control basic hardware or software operation such as the interaction with peripheral components or devices. The memory 625 may be an example of a single memory or multiple memories. For example, the device 605 may include one or more memories 625.

The processor 630 may include an intelligent hardware device (e.g., a general-purpose processor, a digital signal processor (DSP), a central processing unit (CPU), a graphical processing unit (GPU), a neural processing unit (NPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 630 may be configured to operate a memory array using a memory controller. In other cases, a memory controller may be integrated into the processor 630. The processor 630 may be configured to execute computer-readable instructions stored in at least one memory 625 to perform various functions (e.g., functions or tasks supporting tri-matrix low-rank adaptation of artificial intelligence or machine learning models). The processor 630 may be an example of a single processor or multiple processors. For example, the device 605 may include one or more processors 630.

The fine-tuning module 620 may support fine-tuning an AI/ML model in accordance with examples as disclosed herein. For example, the fine-tuning module 620 may be configured to support obtaining a pre-trained model including a first set of parameters associated with a first set of parameter weights. The fine-tuning module 620 may be configured to support generating, as part of a fine-tuning operation associated with fine-tuning the pre-trained model and based on obtaining the first set of parameter weights, a set of matrices that are indicative of a decomposition of a second set of parameter weights associated with a second set of parameters including one or more task-specific parameters for the fine-tuning operation that are different from the first set of parameters, the set of matrices including: one or more first matrices that include a respective first subset of parameter weights from the second set of parameter weights that are associated with a respective first subset of parameters from the second set of parameters, the respective first subset of parameter weights corresponding to one or more values initialized in accordance with a distribution function, and a second matrix that includes a second subset of parameter weights from the second set of parameter weights that are associated with a second subset of parameters from the second set of parameters, the second subset of parameter weights corresponding to one or more uninitialized values. The fine-tuning module 620 may be configured to support training the second matrix by adjusting the one or more uninitialized values of the second subset of parameter weights associated with the second subset of parameters. The fine-tuning module 620 may be configured to support obtaining, via the fine-tuning operation, a fine-tuned model including a fine-tuned set of parameters associated with a fine-tuned set of parameter weights, the fine-tuned model being based on the pre-trained model, where the fine-tuned model is obtained based on training the second matrix and a function of an input associated with the pre-trained model, the first set of parameter weights, an adjustable scaling factor, the set of matrices including the decomposition of the second set of parameter weights associated with the second set of parameters, and a dropout function.

By including or configuring the fine-tuning module 620 in accordance with examples as described herein, the device 605 may support techniques for fine-tuning an AI/ML model to perform respective tasks utilizing techniques that can result in improved user experience related to reduced processing, reduced power consumption, more efficient utilization of communication resources, improved utilization of processing capability, improved utilization of one or more computing components of a computing device or a computing system, or any combination thereof.

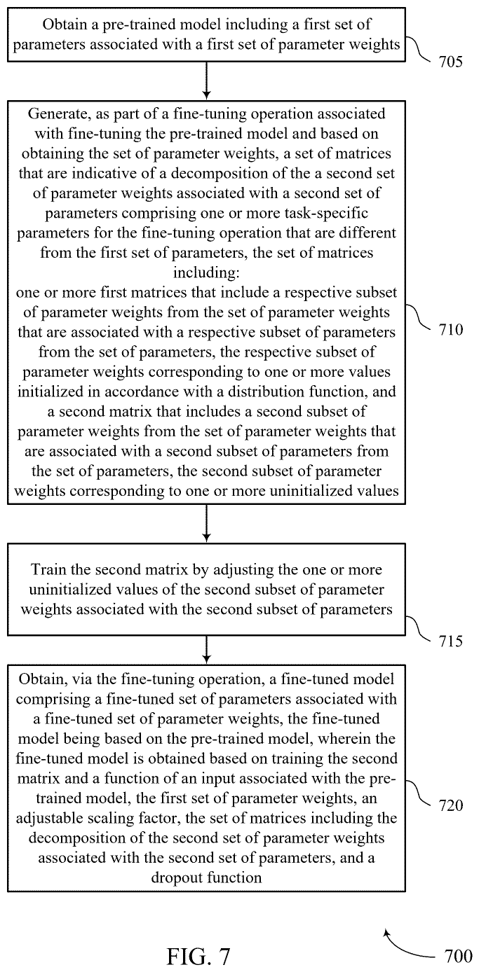

FIG. 7 shows a flowchart illustrating a method 700 that supports tri-matrix low-rank adaptation of artificial intelligence or machine learning models in accordance with aspects of the present disclosure. The operations of the method 700 may be implemented by an AI/ML model or its components as described herein. For example, the operations of the method 700 may be performed by an AI/ML model as described with reference to FIGS. 1 through 6. In some examples, an AI/ML model may execute a set of instructions to control the functional elements of the AI/ML model to perform the described functions. Additionally, or alternatively, the AI/ML model may perform aspects of the described functions using special-purpose hardware.

At 705, the method may include obtaining a pre-trained model including a first set of parameters associated with a first set of parameter weights. The operations of 705 may be performed in accordance with examples as disclosed herein. In some examples, aspects of the operations of 705 may be performed by a pre-trained model parameters receiver 525.

At 710, the method may include generating, as part of a fine-tuning operation associated with fine-tuning the pre-trained model and based on obtaining the first set of parameter weights, a set of matrices that are indicative of a decomposition of a second set of parameter weights associated with a second set of parameters including one or more task-specific parameters for the fine-tuning operation that are different from the first set of parameters, the set of matrices including: one or more first matrices that include a respective first subset of parameter weights from the second set of parameter weights that are associated with a respective first subset of parameters from the second set of parameters, the respective first subset of parameter weights corresponding to one or more values initialized in accordance with a distribution function, and a second matrix that includes a second subset of parameter weights from the second set of parameter weights that are associated with a second subset of parameters from the second set of parameters, the second subset of parameter weights corresponding to one or more uninitialized values. The operations of 710 may be performed in accordance with examples as disclosed herein. In some examples, aspects of the operations of 710 may be performed by a matrix generator 530.

At 715, the method may include training the second matrix by adjusting the one or more uninitialized values of the second subset of parameter weights associated with the second subset of parameters. The operations of 715 may be performed in accordance with examples as disclosed herein. In some examples, aspects of the operations of 715 may be performed by a matrix training component 535.

At 720, the method may include obtaining, via the fine-tuning operation, a fine-tuned model including a fine-tuned set of parameters associated with a fine-tuned set of parameter weights, the fine-tuned model being based on the pre-trained model, where the fine-tuned model is obtained based on training the second matrix and a function of an input associated with the pre-trained model, the first set of parameter weights, an adjustable scaling factor, the set of matrices including the decomposition of the second set of parameter weights associated with the second set of parameters, and a dropout function. The operations of 720 may be performed in accordance with examples as disclosed herein. In some examples, aspects of the operations of 720 may be performed by a fine-tuned model receiver 540.

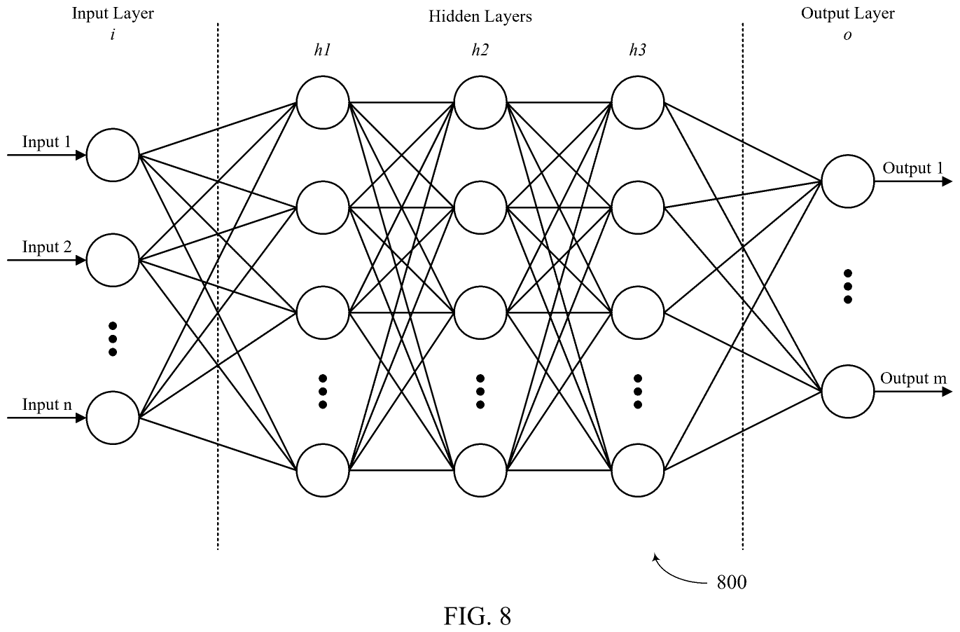

FIG. 8 shows an example of a node diagram 800 that supports tri-matrix low-rank adaptation of AI/ML models in accordance with aspects of the present disclosure. AI models may be programmatic or algorithmic structures that simulate intelligent behavior. ML models may be examples of AI models. ML models are programmatic or algorithmic structures that may be trained to infer or predict an output based on an input. For example, a ML model may be trained using training input data and ground truth data.

ML models may be categorized as unsupervised or supervised. Unsupervised learning may be utilized to draw inferences and find patterns from input data without references to labeled outcomes. Two examples of unsupervised learning models include clustering and dimensionality reduction. Clustering is an unsupervised technique that involves the grouping, or clustering, of data points. Clustering techniques may include k-means clustering, hierarchical clustering, mean shift clustering, and density-based clustering. Dimensionality reduction may be a procedure for reducing a quantity of random variables under consideration by obtaining a set of principal variables. Dimensionality reduction may reduce the dimension of a feature set or reduce a quantity of features). Some dimensionality reduction techniques may be categorized as feature elimination or feature extraction. One example of dimensionality reduction may be referred to as principal component analysis (PCA). PCA may involve projecting higher dimensional data (e.g., three dimensions) to a lower-dimensional space (e.g., two dimensions), which may result in a lower dimension of data (e.g., two dimensions instead of three dimensions) while maintaining one or more variables in the model.

Supervised learning involves learning a function that maps an input to an output based on associated inputs and outputs. For instance, supervised learning may be utilized to draw inferences and find patterns from input data based on labeled data (e.g., training input data with associated ground truth data). A supervised model may sub-categorized as a regression or classification model. Regression models may provide continuous outputs. One example of a regression model is a linear regression, which may determine a line that fits (e.g., best fits) input data. Extensions of linear regression include multiple linear regression (e.g., finding a plane of best fit) and polynomial regression (e.g., finding a curve of best fit).

In classification models, the output may be discrete. One example of a classification model is logistic regression. Logistic regression may be similar to linear regression, but may be used to model a probability for a finite quantity of outcomes. For example, a logistic regression may be utilized such that the output values may be between 0 and 1. Another example of a classification model is a support vector machine. For two classes of data, for example, a support vector machine may determine a hyperplane or a boundary between the two classes of data that maximizes a margin between the two classes. For instance, many planes may separate two classes, while one plane may maximize the margin or distance between the classes. Another example of a classification model is Naïve Bayes, which is based on Bayes Theorem.

Other examples of classification models include decision tree models, random forest models, and neural network models, where an output may be discrete. In a decision tree model, a tree structure is defined with multiple nodes. Decisions may be used to move from a root node at the top of the decision tree to a leaf node (e.g., a node without a child node) at the bottom of the decision tree. A higher quantity of nodes in the decision tree model may correlate with higher decision accuracy.

Random forest models may utilize ensemble learning techniques that build from decision tree models. Random forests involve creating multiple decision trees using bootstrapped datasets of the original data and randomly selecting a subset of variables at each tier of the decision tree. The model may select the mode of all of the predictions of each decision tree. By relying on a “majority wins” model, the risk of error from an individual tree may be reduced.

Another example of an AI/ML model is a neural network (NN). A neural network may be a network of functional nodes. Neural networks may utilize one or more input variables to traverse the nodes and generate one or more output variables. For example, a neural network may utilize an input vector to generate an output vector.

The AI model illustrated in FIG. 8 is an example of a neural network. The neural network includes an input layer i that receives n (one or more) inputs (illustrated as “Input 1,” “Input 2,” and “Input n”), one or more hidden layers (illustrated as hidden layers “h1,” “h2,” and “h3”) for processing the inputs from the input layer, and an output layer o that provides m (one or more) outputs (labeled “Output 1” and “Output m”). While examples of quantities of inputs n, hidden layers h, and outputs m are illustrated in FIG. 8, same or different quantities of inputs, hidden layers, or outputs may be utilized in other examples. In some approaches, the hidden layers h may include linear function(s) or activation function(s) that the nodes (illustrated as circles) of each successive hidden layer process from the nodes of the previous hidden layer.

In some aspects, the AI model illustrated in FIG. 8 or another AI model may be trained in accordance with one or more training techniques. In some examples of the training techniques described herein, one or more AI models (e.g., implemented by one or more devices) may be trained based on training input data (e.g., syslog data, system data, authentication data, and the like) and ground truth data, thereby enabling later determination of an output when an AI model is executed with runtime input data. Ground truth data may be data representing a target output associated with training input data. Ground truth data may also be generated or observed (e.g., empirical) data. In some examples, ground truth data may indicate one or more measurements or values corresponding to training input data.

An AI model (e.g., the AI model illustrated in FIG. 8 or an ML model) may be trained by executing the AI model with the training data to produce an output, comparing the output with the ground truth data, and adjusting weights of the AI model to reduce a disparity between the output and the ground truth data. For example, one or more of the nodes or connections of the AI model may have an associated weight that may be adjusted to modify one or more of the outputs. In some approaches, a cost function may be utilized to compare the output with the ground truth data to indicate a cost (e.g., error or disparity). Adjustments to the weights that reduce the cost may be retained, advanced, or increased, while adjustments to the weights that increase the cost may be discarded, avoided, or decreased. Training procedures, such as the tri-matrix low-rank adaptation procedure described herein in accordance with the techniques of the present disclosure may be repeated or iterated to improve AI model performance. Input data (e.g., runtime input data) may be provided to a trained AI model, which may infer or predict an output based on the input data.

Some examples of the techniques described herein may be performed in conjunction with one or more of the AI models described with reference to FIGS. 2 and 3. For example, an AI/ML model may be fine-tuned to perform one or more tasks in accordance with the techniques of the present disclosure. The techniques of the present disclosure may introduce a tri-matrix low-rank adaptation procedure to fine-tune an AI/ML model. The tri-matrix low-rank adaptation procedure may utilize an adaptive scaling mechanism to reduce the quantity of trainable parameters while maintaining similar performance as other fine-tuning procedures, thus reducing the overall computational overhead, the computational complexity, and the latency associated with fine-tuning an AI/ML model. In accordance with the techniques of the present disclosure, a system may obtain a pre-trained model that includes a set of parameters associated with a set of parameters weights. The system may then generate, as part of a fine-tuning procedure and based on obtaining the first set of parameter weights of the pre-trained model, a set of matrices that are indicative of a decomposition of the set of parameter weights of the pre-trained model. The set of matrices may include one or more first matrices that include a respective subset of parameter weights from the set of parameter weights that correspond to one or more values initialized in accordance with a distribution function. The set of matrices may also include a second matrix that includes a second subset of parameter weights from the set of parameter weights that are associated with a second subset of parameters from the set of parameters. Moreover, the second subset of parameter weights corresponding to one or more uninitialized values.

Based on generating the set of matrices, the system may train the second matrix to initialize the one or more uninitialized values of the second subset of parameter weights associated with the second subset of parameters that correspond to one or more task-specific parameters associated with the fine-tuning operation of the pre-trained model. Further, via the fine-tuning procedure, the computing system 100 may obtain a fine-tuned model that includes a fine-tuned set of parameters associated with a fine-tuned set of parameter weights. The fine-tuned model may be based on the pre-trained model and may be obtained based on training the second matrix and a function of an input associated with the pre-trained model, the set of parameter weights of the pre-trained model, an adjustable scaling factor, the set of matrices, and a dropout function. Thus, the tri-matrix low-rank adaptation procedure described herein may provide for improved AI/ML model performance by fine-tuning the AI/ML model while ensuring both relatively high levels of performance accuracy for a respective task and relatively low levels of computational complexity, resources consumption, and latency.

The following provides an overview of aspects of the present disclosure:

Aspect 1: A method for fine-tuning an AI/ML model, comprising: obtaining a pre-trained model comprising a first set of parameters associated with a first set of parameter weights; generating, as part of a fine-tuning operation associated with fine-tuning the pre-trained model and based at least in part on obtaining the first set of parameter weights, a set of matrices that are indicative of a decomposition of a second set of parameter weights associated with a second set of parameters comprising one or more task-specific parameters for the fine-tuning operation that are different from the first set of parameters, the set of matrices including: one or more first matrices that include a respective first subset of parameter weights from the second set of parameter weights that are associated with a respective first subset of parameters from the second set of parameters, the respective first subset of parameter weights corresponding to one or more values initialized in accordance with a distribution function, and a second matrix that includes a second subset of parameter weights from the second set of parameter weights that are associated with a second subset of parameters from the second set of parameters, the second subset of parameter weights corresponding to one or more uninitialized values; training the second matrix by adjusting the one or more uninitialized values of the second subset of parameter weights associated with the second subset of parameters; and obtaining, via the fine-tuning operation, a fine-tuned model comprising a fine-tuned set of parameters associated with a fine-tuned set of parameter weights, the fine-tuned model being based at least in part on the pre-trained model, wherein the fine-tuned model is obtained based at least in part on training the second matrix and a function of an input associated with the pre-trained model, the first set of parameter weights, an adjustable scaling factor, the set of matrices comprising the decomposition of the second set of parameter weights associated with the second set of parameters, and a dropout function.

Aspect 2: The method of aspect 1, further comprising: obtaining an indication of an instruction to perform the fine-tuning operation, the instruction comprising an indication of one or more tasks; and selecting, from the second set of parameters, a subset of task-specific parameters to train via the fine-tuning operation based at least in part on the subset of task-specific parameters being related to the one or more tasks indicated via the instruction, wherein the second subset of parameters in the second matrix includes the subset of task-specific parameters based at least in part on selecting the subset task-specific parameters.

Aspect 3: The method of any of aspects 1 through 2, further comprising: training, via the fine-tuning operation, the adjustable scaling factor, wherein a balance between the first set of parameters of the pre-trained model and the fine-tuned set of parameters of the fine-tuned model is based at least in part on the training of the adjustable scaling factor.

Aspect 4: The method of aspect 3, wherein the adjustable scaling factor is initialized to a first value prior to training the adjustable scaling factor.

Aspect 5: The method of any of aspects 1 through 4, wherein a quantity of parameters within the second subset of parameters that are trained in accordance with training the second matrix is based at least in part on a rank of the second matrix.

Aspect 6: The method of any of aspects 1 through 5, wherein the function for obtaining the fine-tuned model is based at least in part on a first function of the input associated with the pre-trained model and the first set of parameter weights, and a second function of the adjustable scaling factor, the input associated with the pre-trained model, and a combination of the set of matrices.

Aspect 7: The method of aspect 6, wherein the dropout function is applied to the second function.

Aspect 8: The method of any of aspects 1 through 7, wherein the fine-tuned set of parameter weights of the fine-tuned model is based at least in part on a combination of the first set of parameter weights of the pre-trained model and a function of the adjustable scaling factor and a combination of the set of matrices.

Aspect 9: The method of any of aspects 1 through 8, wherein the distribution function for initializing the one or more values of the one or more first matrices randomly initializes the one or more values of the one or more first matrices.

Aspect 10: The method of any of aspects 1 through 9, wherein the one or more uninitialized values of the second subset of parameter weights in the second matrix of the set of matrices are each initialized to a same first value.

Aspect 11: The method of any of aspects 1 through 10, wherein the pre-trained model is a pre-trained LLM and the fine-tuned model that is based at least in part on the pre-trained model is a fine-tuned LLM that is based at least in part on the pre-trained model.

Aspect 12: An apparatus for fine-tuning an AI/ML model, comprising one or more memories storing processor-executable code, and one or more processors coupled with the one or more memories and individually or collectively operable to execute the code to cause the apparatus to perform a method of any of aspects 1 through 11.

Aspect 13: An apparatus for fine-tuning an AI/ML model, comprising at least one means for performing a method of any of aspects 1 through 11.

Aspect 14: A non-transitory computer-readable medium storing code for fine-tuning an AI/ML model, the code comprising instructions executable by one or more processors to perform a method of any of aspects 1 through 11.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations, and does not represent all the examples that may be implemented, or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, a GPU, an NPU, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by one or more processors, firmware, or any combination thereof. If implemented in software executed by one or more processors, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for fine-tuning an artificial intelligence or machine learning (AI/ML) model, comprising:
obtaining a pre-trained model comprising a first set of parameters associated with a first set of parameter weights;
generating, as part of a fine-tuning operation associated with fine-tuning the pre-trained model and based at least in part on obtaining the first set of parameter weights, a set of matrices that are indicative of a decomposition of a second set of parameter weights associated with a second set of parameters comprising one or more task-specific parameters for the fine-tuning operation that are different from the first set of parameters, the set of matrices including:
one or more first matrices that include a respective first subset of parameter weights from the second set of parameter weights that are associated with a respective first subset of parameters from the second set of parameters, the respective first subset of parameter weights corresponding to one or more values initialized in accordance with a distribution function, and
a second matrix that includes a second subset of parameter weights from the second set of parameter weights that are associated with a second subset of parameters from the second set of parameters, the second subset of parameter weights corresponding to one or more uninitialized values;
training the second matrix by adjusting the one or more uninitialized values of the second subset of parameter weights associated with the second subset of parameters; and
obtaining, via the fine-tuning operation, a fine-tuned model comprising a fine-tuned set of parameters associated with a fine-tuned set of parameter weights, the fine-tuned model being based at least in part on the pre-trained model, wherein the fine-tuned model is obtained based at least in part on training the second matrix and a function of an input associated with the pre-trained model, the first set of parameter weights, an adjustable scaling factor, the set of matrices comprising the decomposition of the second set of parameter weights associated with the second set of parameters, and a dropout function.

2. The method of claim 1, further comprising:
obtaining an indication of an instruction to perform the fine-tuning operation, the instruction comprising an indication of one or more tasks; and
selecting, from the second set of parameters, a subset of task-specific parameters of the one or more task-specific parameters to train via the fine-tuning operation based at least in part on the subset of task-specific parameters being related to the one or more tasks indicated via the instruction, wherein the second subset of parameters in the second matrix includes the subset of task-specific parameters based at least in part on selecting the subset of task-specific parameters.

3. The method of claim 1, further comprising:
training, via the fine-tuning operation, the adjustable scaling factor, wherein a balance between the first set of parameters of the pre-trained model and the fine-tuned set of parameters of the fine-tuned model is based at least in part on the training of the adjustable scaling factor.

4. The method of claim 3, wherein the adjustable scaling factor is initialized to a first value prior to training the adjustable scaling factor.

5. The method of claim 1, wherein a quantity of parameters within the second subset of parameters that are trained in accordance with training the second matrix is based at least in part on a rank of the second matrix.

6. The method of claim 1, wherein the function for obtaining the fine-tuned model is based at least in part on:
a first function of the input associated with the pre-trained model and the first set of parameter weights, and
a second function of the adjustable scaling factor, the input associated with the pre-trained model, and a combination of the set of matrices.

7. The method of claim 6, wherein the dropout function is applied to the second function.

8. The method of claim 1, wherein the fine-tuned set of parameter weights of the fine-tuned model is based at least in part on a combination of the first set of parameter weights of the pre-trained model and a function of the adjustable scaling factor and a combination of the set of matrices.

9. The method of claim 1, wherein the distribution function for initializing the one or more values of the one or more first matrices randomly initializes the one or more values of the one or more first matrices.

10. The method of claim 1, wherein the one or more uninitialized values of the second subset of parameter weights in the second matrix of the set of matrices are each initialized to a same first value.

11. The method of claim 1, wherein the pre-trained model is a pre-trained large language model and the fine-tuned model that is based at least in part on the pre-trained model is a fine-tuned large language model that is based at least in part on the pre-trained model.

12. An apparatus for fine-tuning an artificial intelligence or machine learning (AI/ML) model, comprising:
one or more memories storing processor-executable code; and
one or more processors coupled with the one or more memories and individually or collectively operable to execute the code to cause the apparatus to:
obtain a pre-trained model comprising a first set of parameters associated with a first set of parameter weights;
generate, as part of a fine-tuning operation associated with fine-tuning the pre-trained model and based at least in part on obtaining the first set of parameter weights, a set of matrices that are indicative of a decomposition of a second set of parameter weights associated with a second set of parameters comprising one or more task-specific parameters for the fine-tuning operation that are different from the first set of parameters, the set of matrices including:
one or more first matrices that include a respective first subset of parameter weights from the second set of parameter weights that are associated with a respective first subset of parameters from the second set of parameters, the respective first subset of parameter weights corresponding to one or more values initialized in accordance with a distribution function, and
a second matrix that includes a second subset of parameter weights from the second set of parameter weights that are associated with a second subset of parameters from the second set of parameters, the second subset of parameter weights corresponding to one or more uninitialized values;
train the second matrix by adjusting the one or more uninitialized values of the second subset of parameter weights associated with the second subset of parameters; and
obtain, via the fine-tuning operation, a fine-tuned model comprising a fine-tuned set of parameters associated with a fine-tuned set of parameter weights, the fine-tuned model being based at least in part on the pre-trained model, wherein the fine-tuned model is obtained based at least in part on training the second matrix and a function of an input associated with the pre-trained model, the first set of parameter weights, an adjustable scaling factor, the set of matrices comprising the decomposition of the second set of parameter weights associated with the second set of parameters, and a dropout function.

13. The apparatus of claim 12, wherein the one or more processors are individually or collectively further operable to execute the code to cause the apparatus to:
obtain an indication of an instruction to perform the fine-tuning operation, the instruction comprising an indication of one or more tasks; and
select, from the second set of parameters, a subset of task-specific parameters of the one or more task-specific parameters to train via the fine-tuning operation based at least in part on the subset of task-specific parameters being related to the one or more tasks indicated via the instruction, wherein the second subset of parameters in the second matrix includes the subset of task-specific parameters based at least in part on selecting the subset of task-specific parameters.

14. The apparatus of claim 12, wherein the one or more processors are individually or collectively further operable to execute the code to cause the apparatus to:
training, via the fine-tuning operation, the adjustable scaling factor, wherein a balance between the first set of parameters of the pre-trained model and the fine-tuned set of parameters of the fine-tuned model is based at least in part on the training of the adjustable scaling factor.

15. The apparatus of claim 12, wherein a quantity of parameters within the second subset of parameters that are trained in accordance with training the second matrix is based at least in part on a rank of the second matrix.

16. The apparatus of claim 12, wherein the function to obtain the fine-tuned model is based at least in part on:
a first function of the input associated with the pre-trained model and the first set of parameter weights, and
a second function of the adjustable scaling factor, the input associated with the pre-trained model, and a combination of the set of matrices.

17. The apparatus of claim 12, wherein the fine-tuned set of parameter weights of the fine-tuned model is based at least in part on a combination of the first set of parameter weights of the pre-trained model and a function of the adjustable scaling factor and a combination of the set of matrices.

18. A non-transitory computer-readable medium storing code for fine-tuning an artificial intelligence or machine learning (AI/ML) model, the code comprising instructions executable by one or more processors to:
obtain a pre-trained model comprising a first set of parameters associated with a first set of parameter weights;
generate, as part of a fine-tuning operation associated with fine-tuning the pre-trained model and based at least in part on obtaining the first set of parameter weights, a set of matrices that are indicative of a decomposition of a second set of parameter weights associated with a second set of parameters comprising one or more task-specific parameters for the fine-tuning operation that are different from the first set of parameters, the set of matrices including:
one or more first matrices that include a respective first subset of parameter weights from the second set of parameter weights that are associated with a respective first subset of parameters from the second set of parameters, the respective first subset of parameter weights corresponding to one or more values initialized in accordance with a distribution function, and
a second matrix that includes a second subset of parameter weights from the second set of parameter weights that are associated with a second subset of parameters from the second set of parameters, the second subset of parameter weights corresponding to one or more uninitialized values;
train the second matrix by adjusting the one or more uninitialized values of the second subset of parameter weights associated with the second subset of parameters; and
obtain, via the fine-tuning operation, a fine-tuned model comprising a fine-tuned set of parameters associated with a fine-tuned set of parameter weights, the fine-tuned model being based at least in part on the pre-trained model, wherein the fine-tuned model is obtained based at least in part on training the second matrix and a function of an input associated with the pre-trained model, the first set of parameter weights, an adjustable scaling factor, the set of matrices comprising the decomposition of the second set of parameter weights associated with the second set of parameters, and a dropout function.

19. The non-transitory computer-readable medium of claim 18, wherein the instructions are further executable by the one or more processors to:
obtain an indication of an instruction to perform the fine-tuning operation, the instruction comprising an indication of one or more tasks; and
select, from the second set of parameters, a subset of task-specific parameters of the one or more task-specific parameters to train via the fine-tuning operation based at least in part on the subset of task-specific parameters being related to the one or more tasks indicated via the instruction, wherein the second subset of parameters in the second matrix includes the subset of task-specific parameters based at least in part on selecting the subset of task-specific parameters.

20. The non-transitory computer-readable medium of claim 18, wherein the instructions are further executable by the one or more processors to:
training, via the fine-tuning operation, the adjustable scaling factor, wherein a balance between the first set of parameters of the pre-trained model and the fine-tuned set of parameters of the fine-tuned model is based at least in part on the training of the adjustable scaling factor.
